(19) United States
(12) Patent Application Publication
(10) Pub. No.: US 2023/0281521 A1
(43) Pub. Date: Sep. 7, 2023

(54) INFORMATION PROCESSING APPARATUS, METHOD, AND RECORDING MEDIUM

(71) Applicant: TOYOTA JIDOSHA KABUSHIKI KAISHA, Toyota-shi (JP)

(72) Inventors: Yu NAGATA, Chofu-shi (JP); Ai MIYATA, Sakai-shi (JP); Satoshi KOMAMINE, Nagoya-shi (JP); Syouta KOMATSU, Toyota-shi (JP)

(73) Assignee: TOYOTA JIDOSHA KABUSHIKI KAISHA, Toyota-shi (JP)

(21) Appl. No.: 18/147,255

(22) Filed: Dec. 28, 2022

(30) Foreign Application Priority Data
Feb. 21, 2022 (JP) 2022-024975

(51) Int. Cl. G06Q 10/02; G08G 1/14; G06Q 30/0645

(52) U.S. Cl. CPC G06Q 10/02; G06Q 30/0645; G08G 1/142; G08G 1/147

(57) ABSTRACT

An information processing apparatus includes a processor configured to acquire a vacant time of a front space of a bus stop based on information about operation of a bus associated with the bus stop, and output information about the vacant time of the front space of the bus stop that is acquired, as a time when rental of the front space of the bus stop is allowed. The processor controls display content on a display apparatus placed at the bus stop, based on at least the information about the operation of the bus associated with the bus stop.

### CROSS REFERENCE TO RELATED APPLICATION

This application claims the benefit of Japanese Patent Application No. 2022-024975, filed on Feb. 21, 2022, which is hereby incorporated by reference herein in its entirety.

### BACKGROUND

### Technical Field

The present disclosure relates to an information processing apparatus, a method, and a recording medium.

### Description of the Related Art

There is disclosed a technology for controlling an operation schedule of an on-demand bus based on information about a user waiting for the on-demand bus and a position of the on-demand bus, and for displaying information about the operation schedule of the on-demand bus on a bus stop terminal at a bus stop (for example, Patent document 1).

### CITATION LIST

### Patent Document

[Patent document 1] Japanese Patent Laid-Open No 2018-018533

An aspect of the disclosure is aimed at providing an information processing apparatus and a method that are capable of promoting use of a front space of a bus stop.

### SUMMARY

An aspect of the present disclosure is an information processing apparatus including a processor configured to:
acquire a vacant time of a front space of a bus stop based on information about operation of a bus associated with the bus stop, and
output information about the vacant time of the front space of the bus stop that is acquired, as a time when rental of the front space of the bus stop is allowed.

Another aspect of the present disclosure is a method executed by a computer, the method including:
acquiring a vacant time of a front space of a bus stop based on information about operation of a bus associated with the bus stop; and
outputting information about the vacant time of the front space of the bus stop that is acquired, as a time when rental of the front space of the bus stop is allowed.

Another aspect of the present disclosure is a non-transitory computer-readable recording medium on which a program is recorded, the program for causing a computer to:
receive specification of a first period of time in a vacant time of a front space of a bus stop, and
transmit a request for use of the front space in relation to the first period of time.

According to an aspect of the present disclosure, use of a front space of a bus stop may be promoted.

### BRIEF DESCRIPTION OF DRAWINGS

FIG. 1 is a diagram illustrating an example of a system configuration of a bus stop space rental system according to a first embodiment;

FIG. 2 is a diagram illustrating an example of a sequence of use of rental of the bus stop space, performed between a server and a user terminal;

FIG. 3 is an example of hardware configurations of a server, a signage, and a user terminal;

FIG. 4 is a diagram illustrating an example of functional configurations of a server and a user terminal;

FIG. 5 is a diagram illustrating an example of the schedule for a bus stop space of a bus stop A;

FIG. 6 is a diagram illustrating an example of information that is held in a reservation information database;

FIG. 7 is a diagram illustrating an example of transition of display content on a signage related to rental of a bus stop space;

FIG. 8 is an example of a bus stop space use reservation screen;

FIG. 9 is an example of a flowchart of a schedule creation process by a server for a bus stop space;

FIG. 10 is an example of a flowchart of a reservation reception process by a server;

FIG. 11 is an example of a flowchart of a display control process for a signage by a server;

FIG. 12A is an example of a flowchart of a display control process for a signage by a server;

FIG. 12B is an example of a flowchart of a display control process for a signage by a server;

FIG. 12C is an example of a flowchart of a display control process for a signage by a server;

FIG. 13 is an example of a flowchart of a display control process for a signage by a server;

FIG. 14 is an example of a flowchart of a display control process for a signage by a server;

FIG. 15 is an example of a flowchart for an approaching bus process;

FIG. 16A is an example of a flowchart for a user terminal notification control process by a server;

FIG. 16B is an example of a flowchart for a user terminal notification control process by a server;

FIG. 17 is an example of a flowchart of a use fee acquisition process;

FIG. 18 is an example of a flowchart of a schedule adjustment process;

FIG. 19 is a diagram illustrating an example of a system configuration of a bus stop space rental system according to a second embodiment;

FIG. 20 is an example of an external appearance of a parking meter;

FIG. 21 is a diagram illustrating an example of a hardware configuration of a parking meter; and

FIG. 22 is an example of a flowchart of a control process for a parking meter by a server 1 according to a second embodiment.

### DESCRIPTION OF THE EMBODIMENTS

A parking space for a bus may be secured in front of a bus stop to allow the bus to stop during boarding and alighting of passengers. For example, a parking space is secured in front of a bus stop placed at a bus terminal, a parking lot, a bus bay or the like. However, with a bus stop on a route with a small number of services such as one to ten buses per day or one bus per hour, time when a space in front of the bus stop is not used is long. Accordingly, in an aspect of the present disclosure, promotion of use of a space in front of a bus stop for purposes other than stopping of a bus for boarding and alighting of passengers is proposed.

An aspect of the present disclosure is an information processing apparatus including a processor. The processor is configured to: acquire a vacant time of a front space of a bus stop based on information about operation of a bus associated with the bus stop, and output information about the vacant time of the front space of the bus stop, as a time when rental of the front space of the bus stop is allowed.

The information processing apparatus is a computer that is used as a server, for example. The processor is a processor such as a central processing unit (CPU), for example. The information about operation of a bus associated with a bus stop is a timetable for the bus stop and/or position information of a bus that is scheduled to stop at the bus stop, for example. The timetable for the bus stop is an example of static information indicating operation of the bus. The position information of the bus is an example of dynamic information indicating an operation state of the bus. The vacant time of the front space of the bus stop is a time when a schedule such as a schedule of a bus to stop or a reservation for use by a user is not set, for example.

An output mode of a time when the front space of the bus stop can be rented out may be display on a display apparatus, output in the form of a file in a predetermined format, printing, publication on a predetermined web page, notification by email, push notification and the like, and signage on a signage apparatus, for example.

According to an aspect of the present disclosure, a greater number of people may be notified of the vacant time of the front space of the bus stop, by outputting information about the vacant time of the front space of the bus stop, and use of the front space of the bus stop may thus be promoted. The front space of the bus stop may thus be put to good use.

According to an aspect of the present disclosure, the processor may control display content on a display apparatus placed at the bus stop, based on at least the information about the operation of the bus associated with the bus stop. The display apparatus displays information about use of the front space of the bus stop. The display apparatus that is placed at the bus stop is a bus stop sign provided with an electronic notice board or a display, a digital signage, or a parking meter provided with a display for indicating available or parked, for example. A use state of the front space of a bus stop may thus be notified to surroundings of the bus stop.

In an aspect of the present disclosure, in the vacant time of the front space of the bus stop, the processor may cause the display apparatus to display information indicating that the front space of the bus stop is usable. Information to be displayed on the display apparatus may be text, an image, a moving image or the like, for example. Furthermore, a mode of display of the information indicating that the front space of the bus stop is usable may be display on a screen of the display apparatus, turning on of a light provided on the display apparatus, or the like, for example. By causing the display apparatus to display the information indicating that the front space of the bus stop is usable in the vacant time of the front space of the bus stop, that the front space of the bus stop is currently usable may be notified to surroundings of the bus stop.

In an aspect of the present disclosure, the processor may cause the display apparatus to display the information indicating that the front space of the bus stop is usable, and information indicating until when the front space of the bus stop is usable. The information indicating until when the front space of the bus stop is usable is an end time of a usable state or a remaining usable time length, for example. A time when a space in front of a bus stop is usable by other than buses is limited because a vacant time between operation of buses is used. Displaying the information indicating until when the front space of the bus stop is usable, on the display apparatus placed at the bus stop helps one to determine whether to use the space, or helps to prevent the front space of the bus stop from being used over a long period of time.

In an aspect of the present disclosure, in a case where a first bus scheduled to stop at the bus stop is approaching the bus stop, the processor may change the display content on the display apparatus to information indicating that the front space of the bus stop is not usable. That the first bus scheduled to stop at the bus stop is approaching the bus stop may be detected when a time that is a predetermined time length before a departure time of the first bus on a timetable for the bus stop is reached or when the first bus passes a point that is a predetermined distance before the bus stop or a predetermined check point on an operation route, for example. By changing the display content on the display apparatus when the first bus approaches the bus stop, to information indicating that the front space of the bus stop is not usable, use of the space by other than the first bus may be prevented, and operation of the first bus may be prevented from being interrupted.

In an aspect of the present disclosure, in a case where a use time of the front space of the bus stop is longer than scheduled, the processor may cause the display apparatus to display information urging end of use of the front space of the bus stop. The information urging end of use of the front space of the bus stop may be a warning message. End of use of the front space of the bus stop may thus be urged in a case where the space is used for longer than scheduled.

In an aspect of the present disclosure, the processor may change a stop position of a first bus scheduled to stop at the bus stop to a periphery of the bus stop, in a case where the first bus is detected to be approaching the bus stop and the front space of the bus stop is being used. The processor may cause the display apparatus to display information indicating the stop position of the first bus after change. A passenger waiting at the bus stop for arrival of the first bus may thus be notified of the stop position of the first bus after change. Furthermore, the processor may notify the first bus of the stop position after change. This allows the first bus to stop at the stop position after change when arriving at the bus stop.

In an aspect of the present disclosure, the processor may receive a reservation for use of the front space in relation to a first period of time in the vacant time of the front space of the bus stop. Furthermore, the processor may manage a schedule for the front space of the bus stop based on the information about the operation of the bus associated with the bus stop and information about the reservation for use of the front space of the bus stop. The front space of the bus stop may be used for parking or stopping of a vehicle, holding of an event, opening of a stand or the like, for example. In relation to reception of the reservation for use of the front space of the bus stop, reception from a user terminal via a network may be performed, or input of a user operation from a dedicated terminal placed at the bus stop may be received, or input by an operator receiving the reservation from a user through a call may be performed.

By receiving a reservation for use of the front space of a bus stop and managing a schedule for the front space of the bus stop, use of the front space of the bus stop may be controlled.

Another aspect of the present disclosure may be identified as a method of performing processes of the information processing apparatus described above by a computer. The method is a method executed by a computer, including acquiring a vacant time of a front space of a bus stop based on information about operation of a bus associated with the bus stop; and outputting information about the vacant time of the front space of the bus stop that is acquired, as a time when rental of the front space of the bus stop is allowed. Furthermore, another aspect of the present disclosure may be identified as a program for causing a computer to perform processes of the information processing apparatus described above.

Another aspect of the present disclosure may be identified as a program for causing a computer to receive specification of a first period of time in a vacant time of a front space of the bus stop, and transmit a request for use of the front space in relation to the first period of time. The program is an application program that is placed in a user terminal. A user may thus use the front space of the bus stop in the vacant time. Another aspect of the present disclosure may be identified as a non-transitory computer-readable recording medium for each program described above.

In the following, embodiments of the present disclosure will be described with reference to the drawings. The configuration of the embodiments described below are examples, and the present disclosure is not limited to the configuration of the embodiments.

### First Embodiment

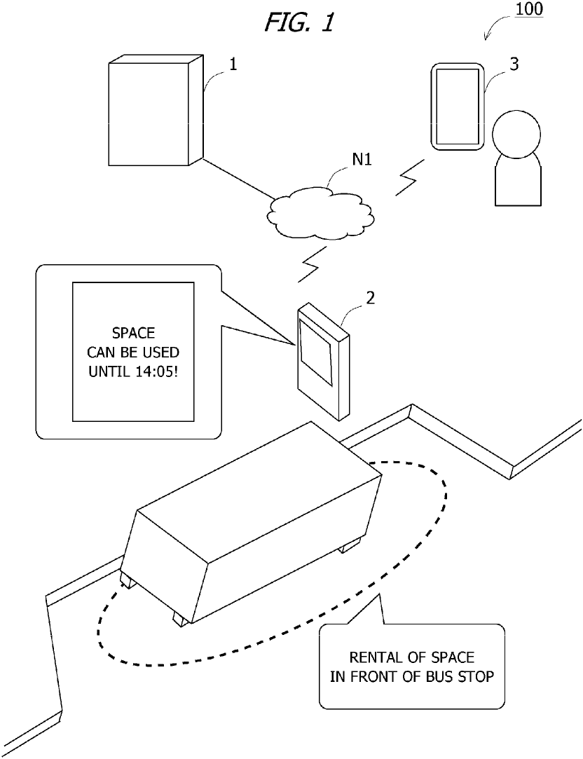

FIG. 1 is a diagram illustrating an example of a system configuration of a bus stop space rental system 100 according to a first embodiment. In the first embodiment, the bus stop space rental system 100 is a system that rents out a front space of a bus stop. In the first embodiment, the bus stop space rental system 100 includes a server 1, a signage 2 placed at a bus stop, and a user terminal 3. Additionally, the bus stop space rental system 100 takes a plurality of bus stops as targets, and includes a plurality of signages 2 placed at respective bus stops, but in the first embodiment, one bus stop and one signage 2 placed at the bus stop will be described as an example for the sake of convenience. Furthermore, the bus stop space rental system 100 includes a plurality of user terminals 3, but FIG. 1 extracts and illustrates one user terminal 3. In the following, a space in front of a bus stop will also be referred to as a bus stop space.

The server 1, the signage 2, and the user terminal 3 are connected to a network N1, and are capable of communication via the network N1. For example, the network N1 is a public network such as the Internet. Additionally, the network through which the server 1 and the signage 2 are connected, and the network through which the server 1 and the user terminal 3 are connected may be different networks. Furthermore, the server 1 and the signage 2 may be connected through a dedicated network that is physically or virtually separated from other networks.

The first embodiment takes as a premise a bus stop of a so-called route bus that travels to each of a plurality of bus stops placed on a fixed route at a fixed time based on an operation table. Furthermore, the bus is assumed to be a bus that runs by being driven by a driver.

The signage 2 is a bus stop sign, a signage placed at the bus stop for advertisement purpose, or a signage placed to be dedicated to the bus stop space rental system 100, for example. The signage 2 includes at least one display, and displays information indicating a use state of the bus stop space on the display.

The user terminal 3 is a terminal where a client application of the bus stop space rental system 100 is installed. A user may make a reservation for use of the bus stop space using the user terminal 3.

For example, the server 1 is a server of a company operating the route bus (also referred to as a bus company or a bus operation company), or a server of a system administrator under contract to provide a service of the bus stop space rental system 100 to the bus company, or the like. In the first embodiment, the server 1 performs a control process related to rental of the bus stop space. Specifically, the server 1 publishes a vacant time of the bus stop space on a predetermined web page, receives a reservation for use from the user terminal 3, and registers the received reservation in a schedule for the bus stop space. Furthermore, in the case where there is occurrence of a delay in operation of the bus, the server 1 adjusts the schedule for the bus stop space by cancelling the reservation for use of the bus stop space included in a predetermined period of time after the delay, for example.

Furthermore, for example, the server 1 determines display content on the signage 2 based on the schedule for the bus stop space, an operation state of the bus, and a use state of the bus stop space, and causes the same to be displayed on the signage 2. For example, in the vacant time of the bus stop space, the server 1 causes information indicating that the bus stop space is usable, and information indicating a use deadline of the bus stop space to be displayed. For example, in the case where the bus stop space is being used by a user, the server 1 causes the signage 2 to display information indicating that the bus stop space is being used.

Furthermore, the reservation for use of the bus stop space is received while avoiding a time when the bus stops at the bus stop, but in reality, use of the bus stop space is sometimes not ended as scheduled. In such a case, even when the bus arrives at the bus stop, the bus stop space is used by another user, and thus, the server 1 changes a stop position of the bus to a periphery of the bus stop, notifies the bus of the change of the stop position of the bus, and causes the signage 2 to display the change.

According to the first embodiment, a general user other than the bus can use the bus stop space in the vacant time of the bus stop space. The bus stop space may thus be put to good use. Additionally, in the first embodiment, how to use the bus stop space that is being rented out is up to the user, and any manner of use is allowed. For example, the bus stop space may be used as a parking lot, a handover location for a package delivered by a vehicle, opening of a stand, holding of an event such as a concert, and the like.

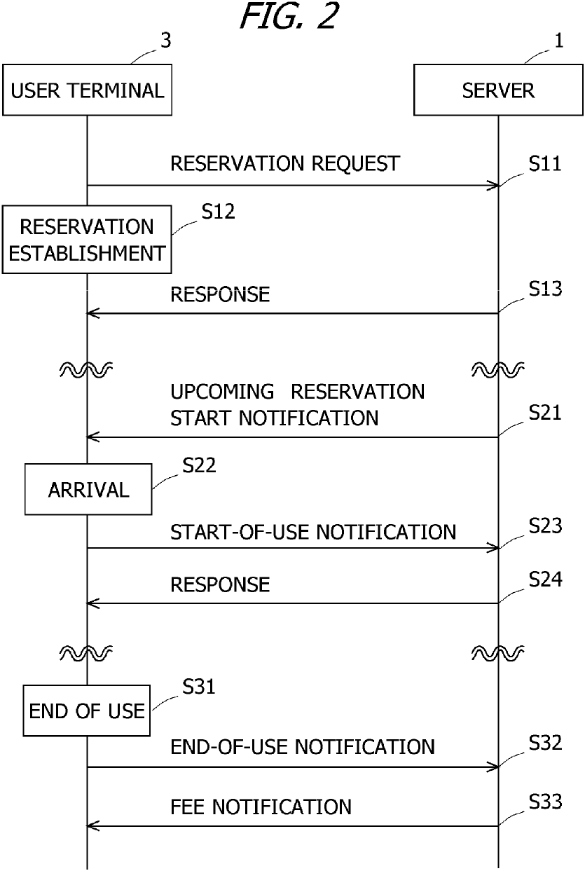

FIG. 2 is a diagram illustrating an example of a sequence of use of rental of the bus stop space, performed between the server 1 and the user terminal 3. FIG. 2 illustrates an example of communication occurring between the server 1 and the user terminal 3 in relation to one bus stop, from reservation for use of rental of the bus stop space to start and end of use of the bus stop space.

S11 to S13 are a sequence at the time of reservation for use of the bus stop space. In S11, the user terminal 3 transmits a reservation request for use of the bus stop space to the server 1, based on input of a user operation. Identification information of the user, identification information of a target bus stop, and scheduled start date and time and scheduled end date and time are also transmitted to the server 1, together with the reservation request, for example. A period of time from the scheduled start date and time to the scheduled end date and time is an example of “first period of time”.

In S12, the server 1 receives the reservation request for use of the bus stop space from the user terminal 3, registers a schedule of use of the bus stop space in a corresponding time slot associated with the corresponding bus stop, and establishes the reservation. In S13, the server 1 transmits, to the user terminal 3, in response to the reservation request, a response indicating establishment of the reservation. Together with the response, identification information of the reservation, the identification information of the user, the identification information of the target bus stop, and the scheduled start date and time and the scheduled end date and time are also transmitted to the user terminal 3 as content of the established reservation, for example. In the following, the user making a reservation for use of the bus stop space will be referred to as a reservation user.

S21 to S24 are a sequence at a time of start of use of the bus stop space. In S21, when a time that is a predetermined time length before the scheduled start date and time of the reservation for use of the bus stop space is reached, the server 1 transmits an upcoming reservation start notification to remind the reservation user. The identification information of the target reservation, the identification information of the target bus stop, and the scheduled start date and time and the scheduled end date and time may also be transmitted to the user terminal 3, together with the upcoming reservation start notification.

In S22, the reservation user arrives at the bus stop space, and starts use of the bus stop space. In the case of starting use of the bus stop space, the reservation user inputs a user operation indicating start of use to the user terminal 3. In S23, the user terminal 3 transmits a start-of-use notification indicating start of use of the bus stop space, to the server 1. For example, the identification information of the target reservation, the identification information of the target bus stop, and the identification information of the user are also transmitted together with the start-of-use notification. In S24, when the start-of-use notification is received from the user terminal 3, the server 1 transmits a response to the user terminal 3. In the following, after use of the bus stop space is started, the user using the bus stop space will be referred to as “space user” (the term meaning user of the bus stop space).

Processes from S31 to S33 are a sequence at the time of end of use of the bus stop space. In S31, the space user ends use of the bus stop space. In the case where use of the bus stop space is ended, the space user inputs a user operation indicating end of use to the user terminal 3. In S32, the user terminal 3 transmits an end-of-use notification indicating end of use of the bus stop space to the server 1. For example, the identification information of the target reservation, the identification information of the target bus stop, and the identification information of the user are also transmitted together with the end-of-use notification.

In S33, when the end-of-use notification is received from the user terminal 3, the server 1 acquires a use fee and notifies the user terminal 3 of the use fee. The use fee for the bus stop space is set on the basis of 5 minutes or 10 minutes, for example, and is higher, the longer the use time. Furthermore, an additional fee may be set depending on a use time zone. Furthermore, a fee may be added in a case where use exceeds the scheduled end date and time. Additionally, the sequence illustrated in FIG. 2 is an example, and the sequence of the bus stop space rental system 100, related to use of the bus stop space, is not limited to the example illustrated in FIG. 2.

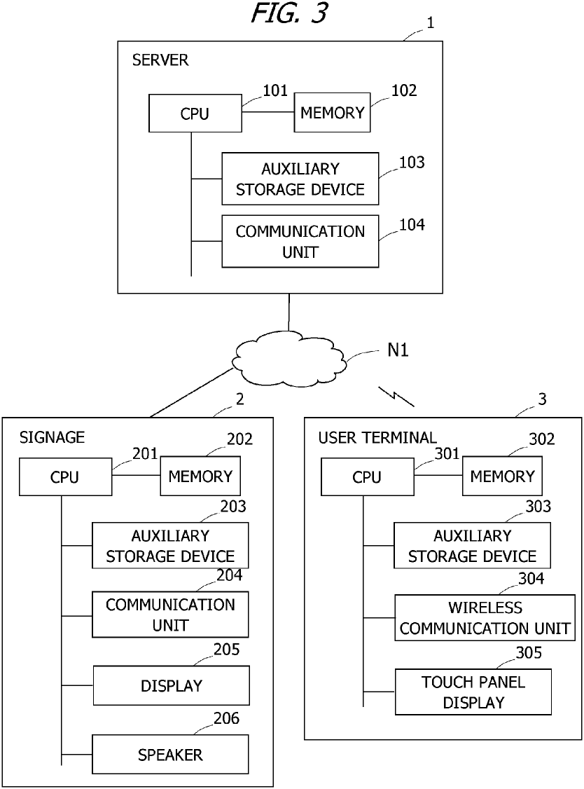

FIG. 3 is an example of hardware configurations of the server 1, the signage 2, and the user terminal 3. As hardware components, the server 1 includes a CPU 101, a memory 102, an auxiliary storage device 103, and a communication unit 104. The memory 102 and the auxiliary storage device 103 are each an example of a computer-readable recording medium.

The auxiliary storage device 103 stores various programs, and data to be used by the CPU 101 at the time of execution of the programs. The auxiliary storage device 103 is a hard disk drive (HDD), a solid state drive (SSD) and the like, for example. The programs held in the auxiliary storage device 103 include an operating system (OS), and a control program of the bus stop space rental system 100, for example. The control program of the bus stop space rental system 100 is a program for a control process related to rental of the bus stop space.

The memory 102 is a main memory that provides the CPU 101 with a storage area and a work area for loading the program stored in the auxiliary storage device 103, and that is used as a buffer. The memory 102 includes semiconductor memories such as a read only memory (ROM), and a random access memory (RAM), for example.

The CPU 101 performs various processes by loading, into the memory 102, and executing the OS and various other programs held in the auxiliary storage device 103. The number of CPUs 101 is not limited to one, and may be more than one. The CPU 101 is an example of “processor”.

The communication unit 104 is, for example, a local area network (LAN) card, or a module connected to a network cable and including a circuit for signal processing such as an optical module or the like. The communication unit 104 is not limited to a circuit that is capable of being connected to a wired network, and may be a wireless signal processing circuit that is capable of processing wireless signals of a wireless communication network such as WiFi. Additionally, the hardware configuration of the server 1 is not limited to the one illustrated in FIG. 3.

As hardware components, the signage 2 includes a CPU 201, a memory 202, an auxiliary storage device 203, a communication unit 204, a display 205, and a speaker 206. The CPU 201, the memory 202, the auxiliary storage device 203, and the communication unit 204 are the same as the CPU 101, the memory 102, the auxiliary storage device 103, and the communication unit 104, respectively. However, the auxiliary storage device 203 holds a display program and the like, in addition to the OS, for example.

For example, the display 205 displays data input from the CPU 201 on a display screen. For example, the display 205 is a liquid crystal display, a plasma display, or an organic EL display. For example, the speaker 206 converts and outputs audio data input from the CPU 201, as audio. Additionally, the hardware configuration of the signage 2 is not limited to the one illustrated in FIG. 3.

As hardware components, the user terminal 3 includes a CPU 301, a memory 302, an auxiliary storage device 303, a wireless communication unit 304, and a touch panel display 305. For example, the user terminal 3 is a smartphone, a tablet terminal, a PC, or a wearable terminal. The CPU 301 and the memory 302 are the same as the CPU 101 and the memory 102. For example, the auxiliary storage device 303 is an erasable programmable ROM (EPROM) or a flash memory. For example, the auxiliary storage device 303 holds a client application program of the bus stop space rental system 100, in addition to the OS.

For example, the wireless communication unit 304 is a wireless communication circuit compatible with a mobile communication method such as 5th Generation (5G), 6G, 4G and Long Term Evolution (LTE), or a wireless communication method such as WiMAX or WiFi. The wireless communication unit 304 connects to an access network by wireless communication, connects to the Internet through the access network, and thus enables communication with external apparatuses.

The touch panel display 305 displays data according to an instruction from the CPU 301, and outputs a signal input by the user to the CPU 301. Additionally, the hardware configuration of the user terminal 3 is not limited to the one illustrated in FIG. 3. For example, in addition to the component elements illustrated in FIG. 3, the user terminal 3 may also include a microphone, a speaker and the like. Furthermore, in the example illustrated in FIG. 3, the signage 2 and the user terminal 3 are different and separate apparatuses, but instead, one apparatus including functions of both the signage 2 and the user terminal 3 may be adopted, for example. In the case where the signage 2 includes a function similar to that of the user terminal 3, for example, the signage 2 may transmit the reservation request for use of the bus stop space, the start-of-use notification, the end-of-use notification and the like to the server 1 by receiving a user operation.

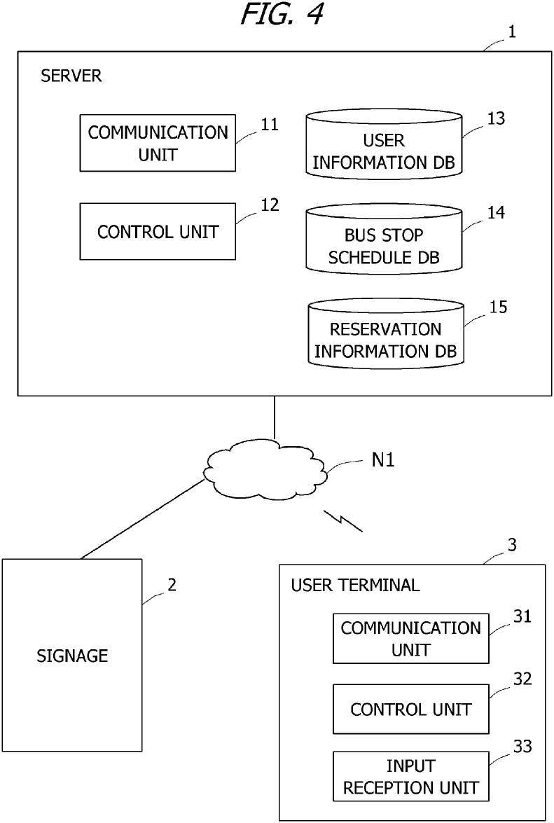

FIG. 4 is a diagram illustrating an example of functional configurations of the server 1 and the user terminal 3. As functional components, the user terminal 3 includes a communication unit 31, a control unit 32, and an input reception unit 33. Processes by these functional components are processes that are achieved by the CPU 301 of the user terminal 3 executing the client application program of the bus stop space rental system 100 held in the auxiliary storage device 303.

The communication unit 31 is an interface to the network N1, and transmits and receives data via the wireless communication unit 304. For example, the communication unit 31 transmits, to the server 1, the reservation request for use of the bus stop space input from the control unit 32. For example, the communication unit 31 receives, from the server 1, a response to the reservation request, and outputs the same to the control unit 32.

The input reception unit 33 receives a user operation that is input via the touch panel display 305. The user operations that are input via the touch panel display 305 include the reservation request for use of the bus stop space, start of use, and end of use, for example. Together with the reservation request, the identification information of the target bus stop, and the scheduled start date and time and the scheduled end date and time of use are also input as content of the reservation, for example. When the user operations regarding start of use and end of use are input, the input reception unit 33 receives timestamps, for example. The input reception unit 33 outputs content of the user operation input via the touch panel display 305, to the control unit 32.

The control unit 32 receives, from the input reception unit 33, notifications regarding input of the user operations regarding the reservation request for use of the bus stop space, start of use, and end of use. The reservation request is input from the input reception unit 33 to the control unit 32 together with information about content of the reservation, and start of use and end of use are input from the input reception unit 33 to the control unit 32 together with respective timestamps.

When the notification regarding input of the user operation for the reservation request for use of the bus stop space is received, the control unit 32 outputs the reservation request for use of the bus stop space to the communication unit 31, and transmits the same to the server 1 via the communication unit 31. Together with the reservation request, the identification information of the user, the identification information of the target bus stop, and the scheduled start date and time and the scheduled end date and time of use are also transmitted to the server 1 as content of the reservation, for example. Furthermore, the control unit 32 receives from the server 1, via the communication unit 31, a response to the reservation request for use of the bus stop space. Together with the response to the reservation request, the identification information of the reservation, the identification information of the user, the identification information of the target bus stop, and the scheduled start date and time and the scheduled end date and time are also received from the server 1, for example. The response to the reservation request may, but not limited to, be received by email or push notification, for example.

When the notification regarding input of the user operation for start of use of the bus stop space is received, the control unit 32 outputs the start-of-use notification to the communication unit 31, and transmits the same to the server 1 via the communication unit 31. Together with the start-of-use notification, the identification information of the reservation, the identification information of the bus stop, the identification information of the user, and the timestamp are also transmitted to the server 1, for example. When the notification regarding input of the user operation for end of use of the bus stop space is received, the control unit 32 outputs the end-of-use notification to the communication unit 31, and transmits the same to the server 1 via the communication unit 31. Together with the end-of-use notification, the identification information of the reservation, the identification information of the bus stop, the identification information of the user, and the timestamp are also transmitted to the server 1, for example.

Next, as functional components, the server 1 includes a communication unit 11, a control unit 12, a user information DB 13, a bus stop schedule DB 14, and a reservation information DB 15. Processes by these functional components are processes that are achieved by the CPU 101 of the server 1 executing the control program of the bus stop space rental system 100 held in the auxiliary storage device 103.

The communication unit 11 is an interface to the network N1. The communication unit 11 outputs data received via the network N1, to the control unit 12. Furthermore, the communication unit 11 transmits data that is input from the control unit 12, to a predetermined apparatus via the network N1.

For example, the control unit 12 performs processes of (1) creation of a schedule for a bus stop space, (2) reception of a reservation for use of the bus stop space, (3) control of display on the signage 2 related to use of the bus stop space, (4) notification and response to the reservation user, and (5) adjustment of a bus stop schedule according to bus delay.

(1) In the creation of a schedule for a bus stop space, the control unit 12 acquires a timetable of the bus stop, and creates the schedule for the bus stop space by taking, as a vacant time of the bus stop space, a time slot excluding a predetermined time length before and after a scheduled arrival/departure time of a bus. The control unit 12 publishes the schedule for the bus stop space that is created, on a predetermined web page, for example.

(2) In the reception of a reservation for use of the bus stop space, the control unit 12 receives the reservation request for use of the bus stop space from the user terminal 3 via the communication unit 11. The identification information of the user, the identification information of the target bus stop, the scheduled use start date and time, and the scheduled use end date and time are also received together with the reservation request, for example. The control unit 12 registers content of the reservation request in the schedule for the bus stop space of the target bus stop. The control unit 12 transmits a response indicating reservation establishment for the reservation request, to the user terminal 3 via the communication unit 11. The identification information of the reservation, the identification information of the user, the identification information of the target bus stop, the scheduled use start date and time, and the scheduled use end date and time may also be transmitted together with the response indicating reservation establishment, for example.

(3) In the control of display on the signage 2 related to use of the bus stop space, the control unit 12 determines display content to be displayed on the signage 2, and transmits the determined display content to the signage 2 to be displayed. The display content on the signage 2 is determined according to the schedule for the bus stop space, an operation state of the bus, and a use state of the bus stop space, for example. The display content that is transmitted to the signage 2 may be any of text, an image, and a moving image, for example.

Control of display on the signage 2 according to the schedule for the bus stop space may be as follows, for example. In the vacant time in the schedule for the bus stop space, for example, the control unit 12 determines information indicating “usable” as the display content on the signage 2. From a time that is a predetermined time length before a departure time of a bus in the schedule for the bus stop space to departure of the bus, for example, the control unit 12 determines information indicating “unusable” as the display content on the signage 2.

Control of display on the signage 2 according to the use state of the bus stop space and the operation state of the bus may be as follows, for example. In the case where a bus is approaching the bus stop, for example, the bus is not able to stop in the bus stop space if the bus stop space is being used by the space user, and thus, the control unit 12 changes a stop position of the bus to a predetermined position in a periphery of the bus stop. For example, the control unit 12 determines information indicating that the stop position of the bus is changed, and information indicating the stop position of the bus after change as the display content on the signage 2. That a bus is approaching the bus stop may be detected based on determination, based on position information of the bus, of passing of the bus of a point at a predetermined distance from the bus stop or passing of a predetermined check point, or when a time that is a predetermined time length before the departure time on the timetable is reached. Details of (3) control of display on the signage 2 will be given later.

(4) In the notification and response to the reservation user, the control unit 12 performs, as processes related to the user terminal 3, transmission of the upcoming reservation start notification, reception of the start-of-use notification from the user terminal 3 and transmission of the response, and reception of the end-of-use notification from the user terminal 3 and notification of a use fee as a response to the notification.

(5) In the adjustment of a bus stop schedule according to bus delay, in the case where there is occurrence of a delay of a predetermined time length or longer in the operation of a bus, for example, the control unit 12 cancels the reservation for use of the bus stop space from a current time to until a predetermined period of time later. This is because, in the case where there is occurrence of a delay in the operation of a bus, the bus does not arrive as specified in the timetable, and moreover, an arrival interval between buses is not known, and it is not clear when a bus will arrive at the bus stop and when a vacant time slot of the bus stop space will be. A delay in the operation of a bus is detected based on the position information of the bus, traffic congestion information and the like, or based on a notification from a bus control center or the like, for example. A delay time of the operation of a bus that causes the schedule for the bus stop space to be adjusted may be freely set by an administrator of the bus stop space rental system 100 between 5 minutes and 30 minutes, for example. Details of the processes of (1) to (5) by the control unit 12 will be given later.

The user information DB 13, the bus stop schedule DB 14, and the reservation information DB 15 are created in a storage area in the auxiliary storage device 103 of the server 1. The user information DB 13 holds information about the user. Information about the user that is held in the user information DB 13 includes the identification information, a name and an address of the user, information about payment, and the like, for example. Information about payment is information such as a credit card number in the case where a payment method is a credit card, for example. Additionally, the use fee of the bus stop space rental system 100 is charged every month, for example.

The bus stop schedule DB 14 holds a daily schedule for the bus stop space of each bus stop. Details of the schedule for the bus stop space will be given later. The reservation information DB 15 holds reservation information related to the bus stop space. Information that is held in the reservation information DB 15 will be described later. Additionally, the functional configurations of the server 1 and the user terminal 3 illustrated in FIG. 4 are examples, and are not limited to the examples illustrated in FIG. 4.

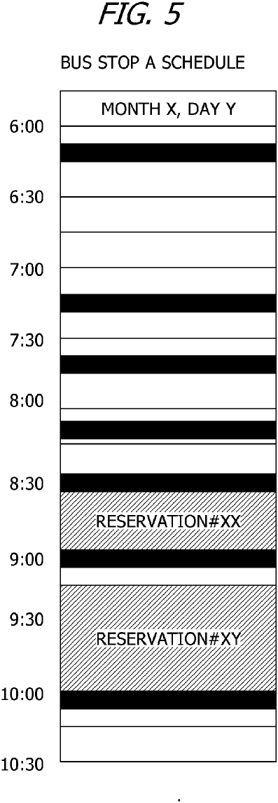

FIG. 5 is a diagram illustrating an example of the schedule for the bus stop space of a bus stop A. FIG. 5 illustrates a part of the schedule for the bus stop space of the bus stop A for month X, day Y. Schedule information as illustrated in FIG. 5 is held in the bus stop schedule DB 14 of the server 1, for each bus stop and for each day.

Black parts in the schedule indicate that the bus stop space of the bus stop A is scheduled to be used by the bus, or in other words, that the bus is scheduled to stop at the bus stop. In the following, the schedule of a bus to stop at a bus stop will be referred to as a bus stopping schedule. The control unit 12 sets the bus stopping schedule to extend over a predetermined time length before and after a departure time of the bus in the timetable, for example. That is, a time that is a predetermined time length before the departure time of the bus in the timetable is a start time of the bus stopping schedule. A time that is a predetermined time length after the departure time in the timetable is set as an end time of the bus stopping schedule.

A time width to be added before and after the departure time of the bus is freely set between 5 minutes and 10 minutes, for example. Additionally, the time width that is added before and after the departure time of the bus in the timetable may be different between before and after the departure time. By setting the bus stopping schedule to have a predetermined time width before and after the departure time of the bus in this manner, a possibility of conflict with another use of the bus stop space may be reduced even when the bus arrives at the bus stop earlier or later than specified in the timetable. As many bus stopping schedules as the number of departure times in the timetable, or in other words, the number of services per day are set.

Hatched parts in the schedule indicate that the bus stop space of the bus stop A is scheduled to be used by a user, or in other words, that there is a reservation for use of the bus stop space. The identification information of the reservation is stored in a scheduled frame for the reservation for use in the schedule. Detailed information of each reservation is held in the reservation information DB 15 described later. Accordingly, time slots when the bus stopping schedule and a schedule of use are not set are the vacant times of the bus stop A, and are the time slots that can be reserved by users for use.

In an initial state, the bus stopping schedule according to the timetable is set in the schedule for the bus stop space, and reservations for use are not set. When a reservation request for use is received from the user terminal 3, the control unit 12 sets a reservation indicated by the reservation request for use, in the schedule for the bus stop space of the corresponding bus stop.

The schedule as illustrated in FIG. 5 may be used as the information about the vacant time of the bus stop space that is published on a website. For example, at a time of reservation for use of a bus stop space, the schedule as illustrated in FIG. 5 may be displayed as the schedule for the bus stop space that is specified by the user for a specified date. In this case, parts corresponding to the vacant time may be made selectable, and parts corresponding to the bus stopping schedule and parts that are reserved by other users for use may be made unselectable. Additionally, the schedule information of the bus stop space is not limited to the example illustrated in FIG. 5.

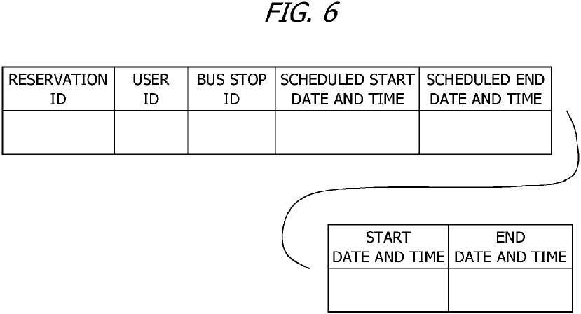

FIG. 6 is a diagram illustrating an example of information that is held in the reservation information DB 15. The reservation information DB 15 holds information about a reservation for use of the bus stop space. One record held in the reservation information DB 15 is information about one reservation. Accordingly, one record in the reservation information DB 15 is created by the control unit 12 when a reservation request is received from the user terminal 3 and a reservation corresponding to the reservation request is established. One record in the reservation information DB 15 includes fields of reservation ID, user ID, bus stop ID, scheduled start date and time, scheduled end date and time, start date and time, and end date and time, for example.

The identification information of a reservation is stored in the field “reservation ID”. The identification information of a reservation is assigned by the control unit 12 in the case when the reservation is established in response to a reservation request. As illustrated in FIG. 5, the identification information of a reservation is also used in the schedule for the bus stop space, for example. The identification information of a user is stored in the field “user ID”. For example, the identification information of a user is assigned by the control unit 12 at the time of user registration in the bus stop space rental system 100.

The identification information of the bus stop that is the target of use is stored in the field “bus stop ID”. For example, the identification information of the bus stop may be assigned by a bus company, or may be independently assigned by the bus stop space rental system 100. The scheduled start date and time and the scheduled end date and time of the bus stop space are stored in the fields “scheduled start date and time” and “scheduled end date and time”, respectively. Values that are stored in the fields “user ID”, “bus stop ID”, “scheduled start date and time”, and “scheduled end date and time” are each information that is received from the user terminal 3 together with the reservation request for use of the bus stop space.

Dates and times when use of the bus stop space is actually started and ended are stored in the fields “start date and time” and “end date and time”, respectively. For example, dates and times indicated by timestamps received from the user terminal 3 together with the start-of-use notification and the end-of-use notification are used as the dates/times when use of the bus stop space is actually started and ended. However, such a case is not restrictive, and the date and time when use of the bus stop space is actually started or stopped may be the date and time when the start-of-use notification or the end-of-use notification is received from the user terminal 3, for example. Additionally, information that is held in the reservation information DB 15 is not limited to the example illustrated in FIG. 6.

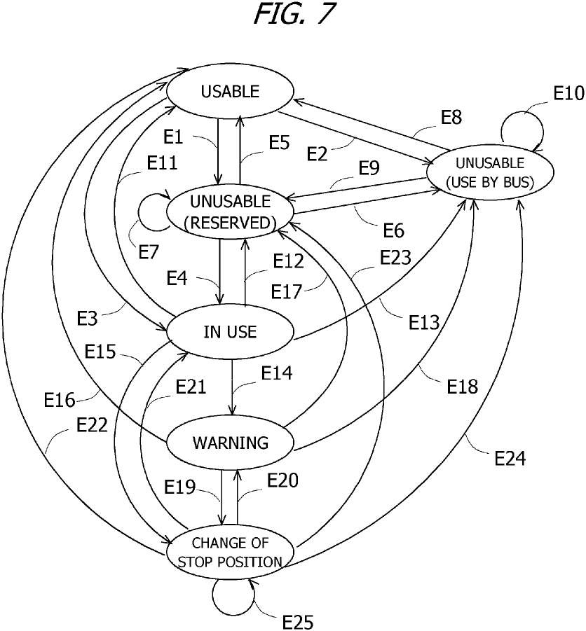

FIG. 7 is a diagram illustrating an example of transition of display content on the signage 2 related to rental of the bus stop space. First, in the first embodiment, display content on the signage 2 related to rental of the bus stop space may include information pieces “usable”, “unusable (reserved)”, “unusable (use by bus)”, “in use”, “warning”, and “change of stop position”.

Information indicating “usable” indicates that the bus stop space is available, and that the bus stop space can be used by any user. Information indicating “unusable (reserved)” indicates that the bus stop space is open but start of next reservation for use is approaching and use of the bus stop space is not allowed, for example. Information indicating “unusable (use by bus)” indicates that the bus stop space is open but start of next bus stopping schedule is approaching and use of the bus stop space is not allowed, for example.

Information indicating “in use” indicates that the bus stop space is being used by a user. Information indicating “warning” indicates that a warning is being issued in relation to end of use, for example. Information indicating “change of stop position” indicates that a stop position of the bus is changed from the bus stop, for example.

Next, transition of the display content will be described. In the first embodiment, there are mainly three types of events that cause transition of the display content on the signage 2. The first type is start and end of a schedule. The second type is reception of various notifications from the user terminal 3. The third type is operation of the bus. Furthermore, a transition destination may be branched depending on a situation of occurrence of an event.

In transition E1, the display content on the signage 2 transitions from information indicating “usable” to information indicating “unusable (reserved)”. The transition E1 takes place in the case where a time that is a predetermined time length before the scheduled start date and time of a reservation is reached.

In transition E2, the display content on the signage 2 transitions from information indicating “usable” to information indicating “unusable (use by bus)”. The transition E2 takes place in the case where a start time of the bus stopping schedule is reached or when the bus is approaching.

In transition E3, the display content on the signage 2 transitions from information indicating “usable” to information indicating “in use”. The transition E3 takes place in the case where the server 1 receives the start-of-use notification from the user terminal 3 of the reservation user. That is, the transition E3 takes place in the case where use of the bus stop space by the reservation user is started at least a predetermined time length before the scheduled start date and time of the reservation.

In transition E4, the display content on the signage 2 transitions from information indicating “unusable (reserved)” to information indicating “in use”. The transition E4 takes place in the case where the server 1 receives the start-of-use notification from the user terminal 3 of the reservation user.

In transition E5, the display content on the signage 2 transitions from information indicating “unusable (reserved)” to information indicating “usable”. The transition E5 takes place in the case where the scheduled end date and time of the reservation is reached and there is subsequently a vacant time of a predetermined period of time or longer.

In transition E6, the display content on the signage 2 transitions from information indicating “unusable (reserved)” to information indicating “unusable (use by bus)”. The transition E6 takes place in the case where the scheduled end date and time of the reservation is reached and there is subsequently a bus stopping schedule, and approach of the bus is detected.

In transition E7, the display content on the signage 2 transitions from information indicating “unusable (reserved)” to information indicating “unusable (reserved)”. The transition E7 takes place in the case where the scheduled end date and time of a reservation is reached and there is a next reservation within a predetermined period of time. That is, the transitions E5 to E7 take place when the reservation user cancels the reservation for use of the bus stop space without notice.

In transition E8, the display content on the signage 2 transitions from information indicating “unusable (use by bus)” to information indicating “usable”. The transition E8 takes place in the case where the bus leaves the bus stop or the end time of the bus stopping schedule is reached, and there is subsequently a vacant time of a predetermined period of time or longer.

In transition E9, the display content on the signage 2 transitions from information indicating “unusable (use by bus)” to information indicating “unusable (reserved)”. Transition E9 takes place in the case where the bus leaves the bus stop or the end time of the bus stopping schedule is reached, and there is subsequently a next reservation within a predetermined period of time.

In transition E10, the display content on the signage 2 transitions from information indicating “unusable (use by bus)” to information indicating “unusable (use by bus)”. The transition E10 takes place in the case where the bus leaves the bus stop or the end time of the bus stopping schedule is reached, and there is subsequently a next bus stopping schedule.

In transition E11, the display content on the signage 2 transitions from information indicating “in use” to information indicating “usable”. The transition E11 takes place in the case where the server 1 receives the end-of-use notification from the user terminal 3 of the space user, and there is subsequently a vacant time of a predetermined period of time or longer.

In transition E12, the display content on the signage 2 transitions from information indicating “in use” to information indicating “unusable (reserved)”. The transition E12 takes place in the case where the server 1 receives the end-of-use notification from the user terminal 3 of the space user, and there is subsequently a next reservation within a predetermined period of time.

In transition E13, the display content on the signage 2 transitions from information indicating “in use” to information indicating “unusable (use by bus)”. The transition E13 takes place in the case where the server 1 receives the end-of-use notification from the user terminal 3 of the space user, and there is subsequently a bus stopping schedule.

In transition E14, the display content on the signage 2 transitions from information indicating “in use” to information indicating “warning”. The transition E14 takes place in the case where the scheduled end date and time is reached without the server 1 receiving the end-of-use notification from the user terminal 3 of the space user. That is, the transition E14 takes place in the case where use of the bus stop space by the user exceeds the scheduled end date and time.

In transition E15, the display content on the signage 2 transitions from information indicating “in use” to information indicating “change of stop position”. The transition E15 takes place in the case where the stop position of the bus is changed to a predetermined position in the periphery of the bus stop due to the bus stop space being used by a user when approach of the bus is detected.

In transition E16, the display content on the signage 2 transitions from information indicating “warning” to information indicating “usable”. The transition E16 takes place in the case where the server 1 receives the end-of-use notification from the user terminal 3 of the space user, and there is subsequently a vacant time of a predetermined period of time or longer.

In transition E17, the display content on the signage 2 transitions from information indicating “warning” to information indicating “unusable (reserved)”. The transition E17 takes place in the case where the server 1 receives the end-of-use notification from the user terminal 3 of the space user, and there is subsequently a next reservation within a predetermined period of time.

In transition E18, the display content on the signage 2 transitions from information indicating “warning” to information indicating “unusable (use by bus)”. The transition E18 takes place in the case where the server 1 receives the end-of-use notification from the user terminal 3 of the space user, and there is subsequently a bus stopping schedule.

In transition E19, the display content on the signage 2 transitions from information indicating “warning” to information indicating “change of stop position”. The transition E19 takes place in the case where the stop position of the bus is changed to a predetermined position in the periphery of the bus stop due to the bus stop space being used by a user when approach of the bus is detected.

In transition E20, the display content on the signage 2 transitions from information indicating “change of stop position” to information indicating “warning”. The transition E20 takes place in the case where arrival and departure of the bus from the stop position after change are detected, and the bus stop space is being used beyond the scheduled end date and time.

In transition E21, the display content on the signage 2 transitions from information indicating “change of stop position” to information indicating “in use”. The transition E21 takes place in the case where arrival and departure of the bus from the stop position after change are detected, and the bus stop space continues to be used without the scheduled end date and time being expired.

In transition E22, the display content on the signage 2 transitions from information indicating “change of stop position” to information indicating “usable”. The transition E22 takes place in the case where arrival and departure of the bus from the stop position after change are detected, use of the bus stop space is ended, and there is subsequently a vacant time of a predetermined period of time or longer.

In transition E23, the display content on the signage 2 transitions from information indicating “change of stop position” to information indicating “unusable (reserved)”. The transition E23 takes place in the case where arrival and departure of the bus from the stop position after change are detected, use of the bus stop space is ended, and there is subsequently a reservation within a predetermined period of time.

In transition E24, the display content on the signage 2 transitions from information indicating “change of stop position” to information indicating “unusable (use by bus)”. The transition E24 takes place in the case where arrival and departure of the bus from the stop position after change are detected, use of the bus stop space is ended, and there is subsequently a bus stopping schedule or a bus is approaching.

In transition E25, the display content on the signage 2 transitions from information indicating “change of stop position” to information indicating “change of stop position”. The transition E25 takes place in the case where arrival and departure of the bus from the stop position after change are detected, use of the bus stop space is continued, and there is subsequently a bus stopping schedule or a bus is approaching.

Additionally, the display content on the signage 2 related to the bus stop space rental system 100, and transition of the display content on the signage 2 are not limited to the example illustrated in FIG. 7. For example, information indicating until when use is allowed may be displayed on the signage 2, together with information indicating “usable”. Information indicating until when use is allowed is a time when a usable state ends, or a remaining time length when the usable state continues. Furthermore, a scheduled time when the usable state will be reached or a time length until the usable state will be reached may be displayed on the signage 2, together with information pieces indicating “unusable (reserved)”, “unusable (use by bus)”, and “in use”. Moreover, information indicating the stop position of the bus after change may be displayed on the signage 2, together with information indicating “change of stop position”. Information indicating the stop position of the bus after change includes a message, a map, a sign, and the like, for example.

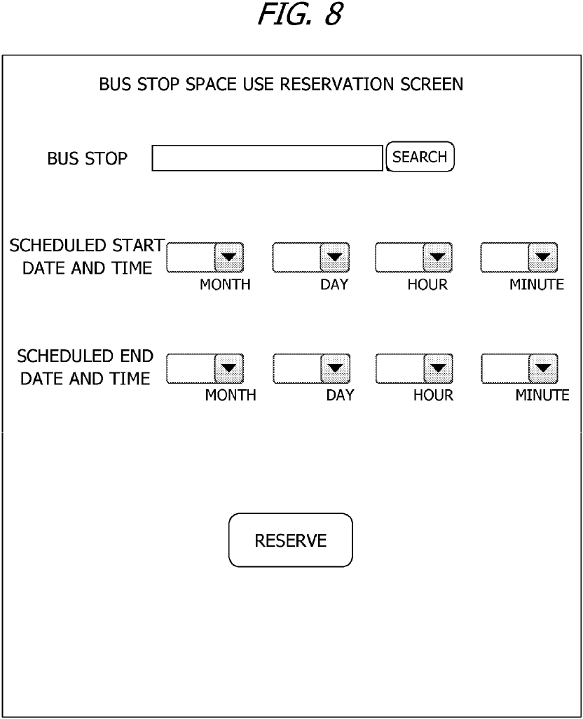

FIG. 8 is an example of a bus stop space use reservation screen. The bus stop space use reservation screen is a screen where a reservation for use of the front space of a specified bus stop is made. The bus stop space use reservation screen is displayed on the user terminal 3, for example.

An input section is provided on the bus stop space use reservation screen for each of the bus stop, the scheduled start date and time, and the scheduled end date and time. The bus stop may be selected from a search result obtained by performing a search with a keyword or may be selected on a map, or the bus line and the bus stop may be selected from a drop-down menu. When a reserve button is selected, the reservation request, and the bus stop, the scheduled start date and time, and the scheduled end date and time that are input are transmitted to the server 1. Additionally, the bus stop space use reservation screen is not limited to the example illustrated in FIG. 8.

### Flow of Processes

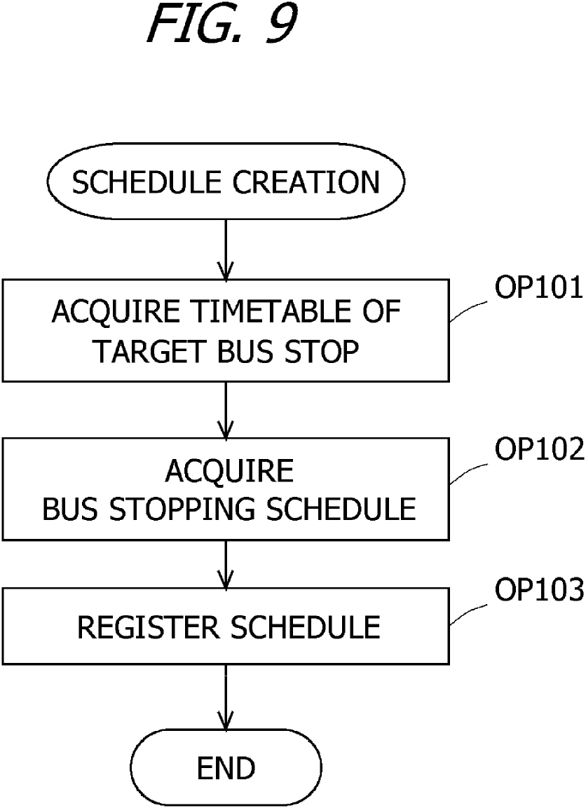

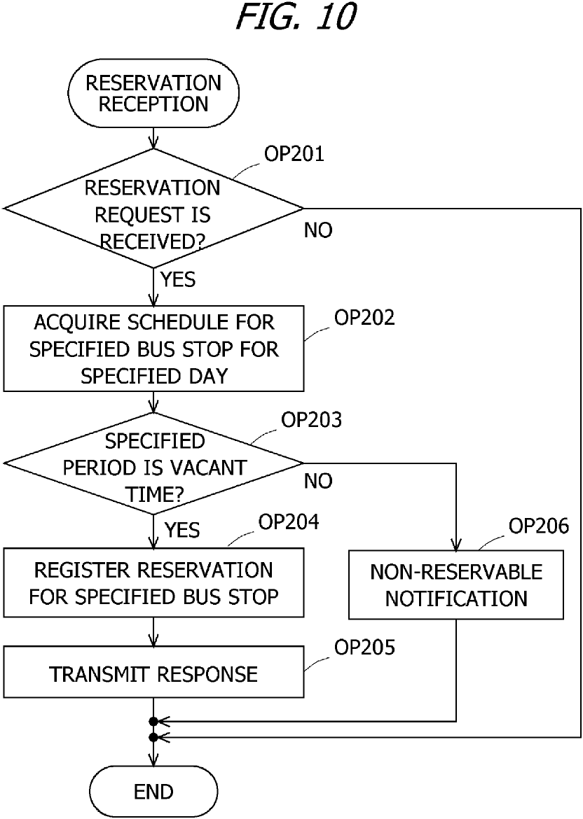

FIG. 9 is an example of a flowchart of a schedule creation process by the server 1 for the bus stop space. For example, the process illustrated in FIG. 9 is started when reception of a reservation for use of the bus stop space is started. For example, in the case where a reservation for use of the bus stop space is received from 30 days before a use date, the process illustrated in FIG. 9 is performed every day at twelve midnight for a day that is 30 days later. However, an execution timing of the process illustrated in FIG. 9 is not limited thereto. The process illustrated in FIG. 9 is performed for each bus stop on a target day. Furthermore, a main performer of the process illustrated in FIG. 9 is the CPU 101 of the server 1, but a functional component will be described as the performer for the sake of convenience. The same applies to flowcharts in FIG. 10 and subsequent drawings.

In OP101, the control unit 12 acquires the timetable of a target bus stop for a target day. The timetable of the target bus stop may be acquired from the operation company of a target bus via a network, or may be acquired from the auxiliary storage device 103 holding the target timetable that is acquired in advance. Additionally, the timetable of the bus may be different for weekdays, Saturday, and Sunday and holiday, for example.

In OP102, the control unit 12 acquires the bus stopping schedule on the target day. The bus stopping schedule is set to extend over a predetermined time length before and after a departure time in the timetable acquired in OP101. As many bus stop schedules as the number of departure times in the timetable, or in other words, the number of services are acquired.

In OP103, the control unit 12 registers at least one bus stopping schedule acquired in OP102 in the schedule, in the bus stop schedule DB 14, for the bus stop space of the target bus stop on the target day. Then, the process illustrated in FIG. 9 is ended. Additionally, the schedule creation process is not limited to the example illustrated in FIG. 9.

FIG. 10 is an example of a flowchart of a reservation reception process by the server 1. The process illustrated in FIG. 10 is repeatedly performed every predetermined period. In OP201, the control unit 12 determines whether a reservation request is received from the user terminal 3 or not. In the case where a reservation request is received from the user terminal 3 (OP201: YES), the process proceeds to OP202. For example, the identification information of the user, the identification information of the bus stop that is specified, the scheduled start date and time, and the scheduled end date and time are also received from the user terminal 3, together with the reservation request. In the case where a reservation request is not received from the user terminal 3 (OP201: NO), the process illustrated in FIG. 10 is ended.

In OP202, the control unit 12 acquires the schedule for a specified day for the bus stop that is specified, from the bus stop schedule DB 14. The specified day is a day that is indicated by the scheduled start date and time and the scheduled end date and time that are received together with the reservation request.

In OP203, the control unit 12 determines whether a specified period corresponds to the vacant time of the bus stop space of the bus stop that is specified. The specified period is a period of time that is indicated by the scheduled start date and time and the scheduled end date and time received together with the reservation request. In the case where the specified period corresponds to the vacant time of the bus stop space of the bus stop that is specified (OP203: YES), the process proceeds to OP204. In OP204, the control unit 12 updates the bus stop schedule DB 14 by registering the reservation in the bus stop schedule for the bus stop that is specified. In OP205, the control unit 12 transmits a response for the reservation request, to the user terminal 3. Content of the reservation that is established (the identification information of the bus stop, the scheduled start date and time, and the scheduled end date and time) is also transmitted to the user terminal 3, together with the response. The process illustrated in FIG. 10 is then ended.

In the case where the specified period does not correspond to the vacant time of the bus stop space of the bus stop that is specified (OP203: NO), the process proceeds to OP206. In OP206, the control unit 12 transmits, to the user terminal 3, a non-reservable notification indicating that reservation is not allowed in the specified period. Then, the process illustrated in FIG. 10 is ended. Additionally, the reservation reception process is not limited to the example illustrated in FIG. 10.

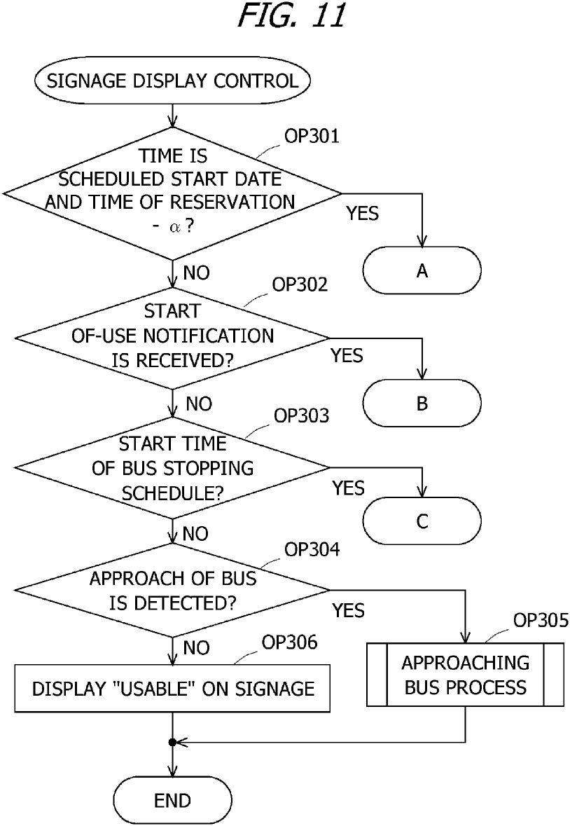

FIGS. 11, 12A, 12B, 12C, 13, and 14 are examples of a flowchart of a display control process for the signage 2 by the server 1. The processes illustrated in FIGS. 11 to 14 are repeatedly performed every predetermined period. The processes illustrated in FIGS. 11 to 14 are performed for each bus stop. In FIGS. 11 to 14, a bus stop that is a processing target will be referred to as a target bus stop. Furthermore, a reservation for use of a bus stop space will be simply referred to as a reservation.

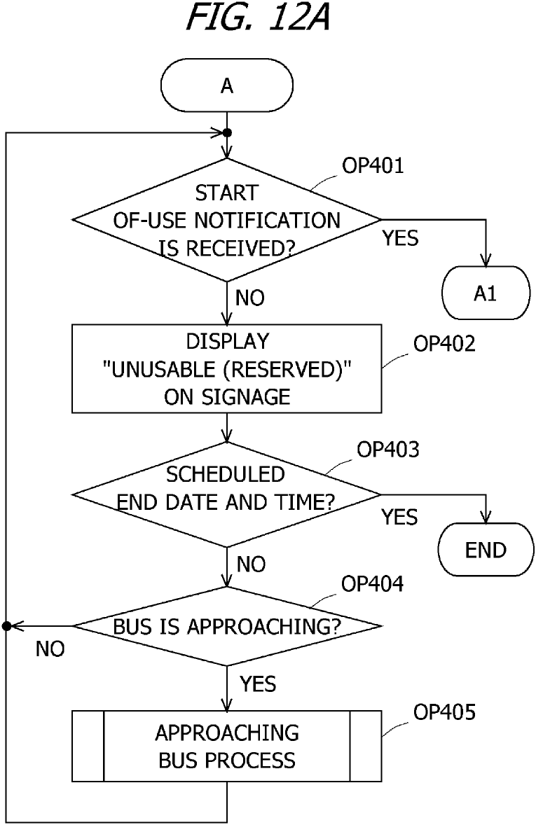

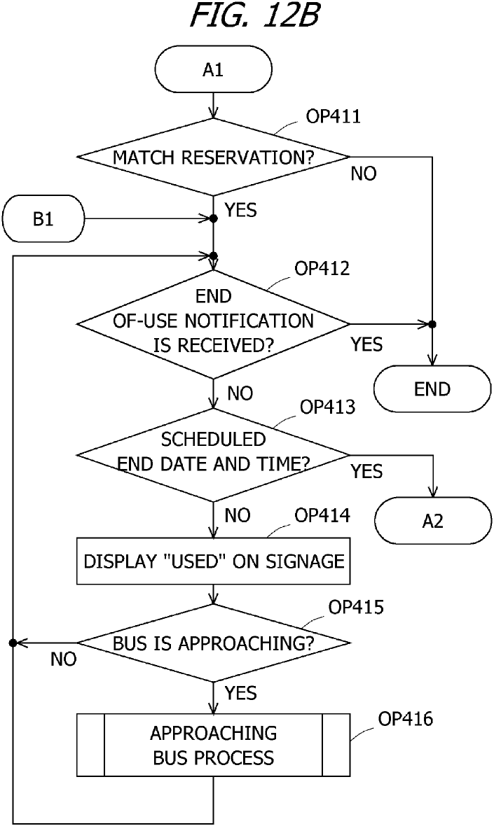

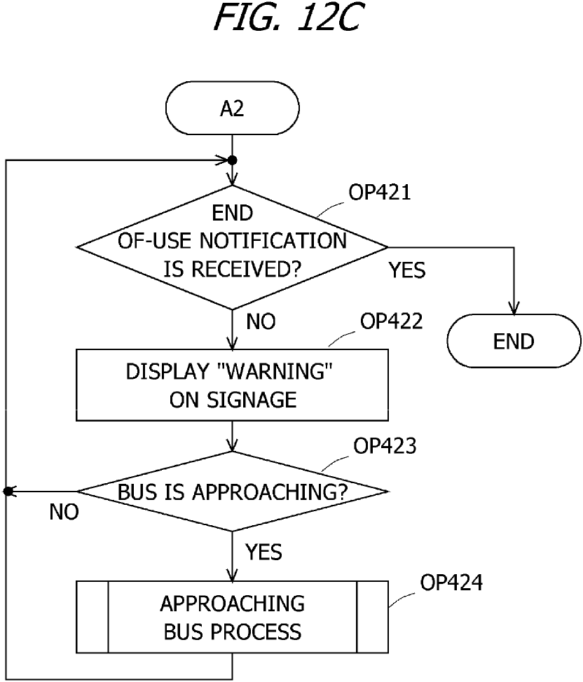

In OP301, the control unit 12 determines, based on the schedule for the target bus stop, whether a time that is a predetermined time length (“α” in the drawing) before the scheduled start date and time of the reservation is reached or not. In the case where the time that is the predetermined time length before the scheduled start date and time of the reservation is reached (OP301: YES), the process proceeds to OP401 in FIG. 12A. In the case where the time that is the predetermined time length before the scheduled start date and time of the reservation is not reached (OP301: NO), the process proceeds to OP302.

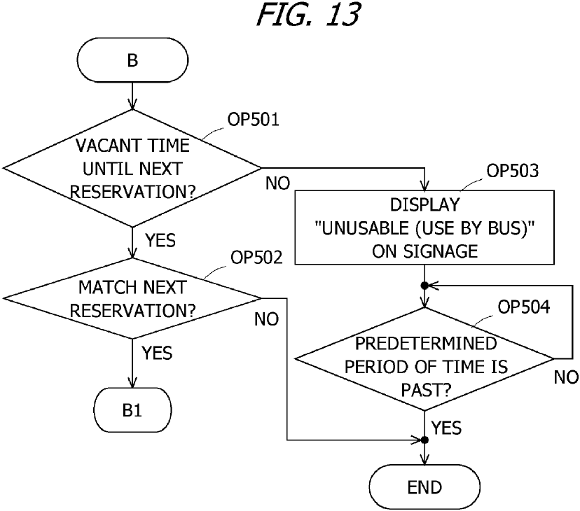

In OP302, the control unit 12 determines whether the start-of-use notification is received from the user terminal 3 or not. The start-of-use notification based on which a positive determination is made in OP302 is the start-of-use notification together with which the identification information of the target bus stop is received. In the case where the start-of-use notification is received from the user terminal 3 (OP302: YES), the process proceeds to OP501 in FIG. 13. In the case where the start-of-use notification is not received from the user terminal 3 (OP302: NO), the process proceeds to OP303.

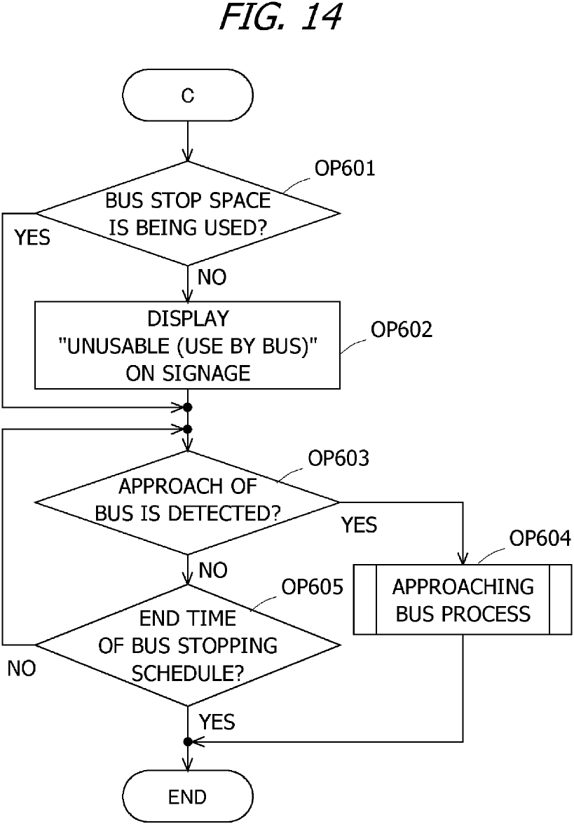

In OP303, the control unit 12 determines, based on the schedule for the target bus stop, whether the start time of the bus stopping schedule is reached or not. In the case where the start time of the bus stopping schedule is reached (OP303: YES), the process proceeds to OP601 in FIG. 14. In the case where the start time of the bus stopping schedule is not reached (OP303: NO), the process proceeds to OP304.

In OP304, the control unit 12 determines whether approach of a bus that is scheduled to stop at the target bus stop is detected or not. The identification information of the bus that is scheduled to stop at the target bus stop, or in other words, a bus assigned to each service on the route including the target bus stop is acquired from the operation company of the bus. In the following, a simple term “bus” indicates the bus that is scheduled to stop at the target bus stop.

Together with the identification information of itself, the bus transmits position information to the server 1 every predetermined period. For example, approach of the bus is detected by the control unit 12 based on the position information of the bus, when a distance between the target bus stop and the bus falls to or below a predetermined distance or when the bus passes by a check point that is set before the target bus stop.

In the case where approach of the bus to the target bus stop is detected (OP304: YES), the process proceeds to OP305. In OP305, the control unit 12 performs an approaching bus process. The approaching bus process is a process of determining, when approach of the bus to the bus stop is detected, the stop position of the bus according to the use state of the bus stop space. Details of the process in OP305 will be given later. When the approaching bus process in OP305 is ended, the process illustrated in FIG. 11 is ended.

In the case where approach of the bus to the target bus stop is not detected (OP304: NO), the process proceeds to OP306. In OP306, the control unit 12 determines information indicating “usable” as the display content on the signage 2, and transmits a display instruction to the signage 2. The signage 2 thus displays information indicating “usable”. Then, the process illustrated in FIG. 11 is ended.

Processes illustrated in FIGS. 12A to 12C are examples of processes that are performed after the scheduled start date and time of a reservation for use of the front space of the target bus stop. In FIGS. 12A to 12C, a reservation, the scheduled start date and time of which is reached, is referred to as a target reservation. FIG. 12A is a process performed between the scheduled start date and time of the reservation for use of the front space of the target bus stop and when use of the front space of the target bus stop is started. A reservation, the scheduled start date and time of which is determined as reached in OP301 in FIG. 11, is referred to as the target reservation.

In OP401, the control unit 12 determines whether the start-of-use notification is received from the user terminal 3 or not. The start-of-use notification based on which a positive determination is made in OP401 is the start-of-use notification together with which the identification information of the target bus stop is received. In the case where the start-of-use notification is received from the user terminal 3 (OP401: YES), the process proceeds to OP411 in FIG. 12B. In the case where the start-of-use notification is not received from the user terminal 3 (OP401: NO), the process proceeds to OP402.

In OP402, the control unit 12 determines information indicating “unusable (reserved)” as the display content on the signage 2, and transmits a display instruction to the signage 2. The signage 2 thus displays information indicating “unusable (reserved)”, and use of the bus stop space by users other than the reservation user may be prevented for a predetermined period of time after the scheduled start date and time of the reservation.

In OP403, the control unit 12 determines whether the scheduled end date and time of the target reservation is reached or not. In the case where the scheduled end date and time of the target reservation is not reached (OP403: NO), the process proceeds to OP404.

In the case where the scheduled end date and time of the target reservation is reached (OP403: YES), the processes illustrated in FIGS. 11 and 12A are ended. Then, the processes are repeated from OP301 in FIG. 11. In this case, it is indicated that the scheduled end date and time of the reservation is reached without use of the bus stop space by the reservation user being started even when the scheduled start date and time of the reservation is past, or in other words, that the reservation is cancelled by the reservation user without notice.

In OP404, the control unit 12 determines whether approach of the bus to the target bus stop is detected or not. In the case where approach of the bus is detected (OP404: YES), the process proceeds to OP405. In OP405, the control unit 12 performs the approaching bus process. Then, the process proceeds to OP401, and the process in FIG. 12A is repeated. In the case where approach of the bus is not detected (OP404: NO), the process proceeds to OP401, and the process in FIG. 12A is repeated.

FIG. 12B is an example of a process performed in a case where the start-of-use notification is received from the user terminal 3. In OP411, the control unit 12 determines whether the start-of-use notification that is received is the start-of-use notification for the target reservation or not. Specifically, the control unit 12 determines whether the identification information of the reservation that is received together with the start-of-use notification matches the identification information of the target reservation or not. In the case where the start-of-use notification that is received is the start-of-use notification for the target reservation (OP411: YES), the process proceeds to OP412. In the case where the start-of-use notification that is received is not the start-of-use notification for the target reservation (OP411: NO), the processes illustrated in FIGS. 11 and 12B are ended.

In OP412, the control unit 12 determines whether the end-of-use notification is received from the user terminal 3 or not. In OP412, a positive determination is made in a case where the identification information of the reservation that is received together with the end-of-use notification matches the identification information of the target reservation. In the case where the end-of-use notification is received from the user terminal 3 (OP412: YES), the processes illustrated in FIGS. 11 and 12B are ended. In the case where the end-of-use notification is not received from the user terminal 3 (OP412: NO), the process proceeds to OP413.

In OP413, the control unit 12 determines whether the scheduled end date and time of the target reservation is reached or not. In the case where the scheduled end date and time of the target reservation is reached (OP413: YES), the process proceeds to OP421 in FIG. 12C. In the case where the scheduled end date and time of the target reservation is not yet reached (OP413: NO), the process proceeds to OP414.

In OP414, the control unit 12 determines information indicating “in use” as the display content on the signage 2, and transmits a display instruction to the signage 2. The signage 2 thus displays information indicating “in use”.

In OP415, the control unit 12 determines whether approach of the bus to the target bus stop is detected or not. In the case where approach of the bus is detected (OP415: YES), the process proceeds to OP416. In OP416, the control unit 12 performs the approaching bus process. Then, the process proceeds to OP412, and the processes are repeated from OP412. In the case where approach of the bus is not detected (OP415: NO), the process proceeds to OP412, and the processes are repeated from OP412.

FIG. 12C is an example of a process performed in a case where use of the bus stop space continues beyond the scheduled end date and time. In OP421, the control unit 12 determines whether the end-of-use notification is received from the user terminal 3 or not. In the case where the end-of-use notification is received from the user terminal 3 (OP421: YES), the processes illustrated in FIGS. 11 and 12C are ended. In the case where the end-of-use notification is not received from the user terminal 3 (OP421: NO), the process proceeds to OP422.

In OP422, the control unit 12 determines information indicating “warning” as the display content on the signage 2, and transmits a display instruction to the signage 2. The signage 2 thus displays information indicating “warning”.

In OP423, the control unit 12 determines whether approach of the bus to the target bus stop is detected or not. In the case where approach of the bus is detected (OP423: YES), the process proceeds to OP424. In OP424, the control unit 12 performs the approaching bus process. Then, the process proceeds to OP421, and the processes are repeated from OP421. In the case where approach of the bus is not detected (OP423: NO), the process proceeds to OP421, and the processes are repeated from OP421.

In OP402, in the case where a time until the start date and time of the next reservation is shorter than a predetermined time length, the signage 2 is caused to display information indicating “unusable” to prevent the bus stop space from being used by a user in the time until the next schedule. This is because if a new reservation for use is received even when the time when the bus stop space can be used is a short time such as 5 minutes, for example, use by the new reservation is highly likely to continue beyond the scheduled start date and time of a subsequent reservation for use.

FIG. 13 is a process performed in a case where the start-of-use notification is received from the user terminal 3 a predetermined time length or longer before the scheduled start date and time of the reservation, and is a process performed in a case where the reservation user starts using the bus stop space a predetermined time length or longer before the scheduled start date and time of the reservation, for example.

In OP501, the control unit 12 refers to the schedule for the front space of the target bus stop, and determines whether between a current time and the next reservation is the vacant time or not. In the case where it is the vacant time until the next reservation (OP501: YES), the process proceeds to OP502. In the case where it is not the vacant time between the current time and the next reservation, or in other words, in the case where there is a bus stopping schedule before the next reservation (OP501: NO), the process proceeds to OP503.

In OP502, the control unit 12 determines whether the start-of-use notification that is received is the start-of-use notification for the next reservation or not. In the case where the start-of-use notification that is received is the start-of-use notification for the next reservation (OP502: YES), because the bus stop space is available until the scheduled start date and time of the reservation, start of reservation corresponding to the start-of-use notification that is received is permitted, and the process proceeds to OP412 in FIG. 12B.

In the case where the start-of-use notification that is received is not the start-of-use notification for the next reservation (OP502: NO), the start-of-use notification that is received is not accepted, and the processes illustrated in FIGS. 11 and 13 are ended.

In OP503, the control unit 12 determines information indicating “unusable (use by bus)” as the display content on the signage 2, and transmits a display instruction to the signage 2. The signage 2 thus displays information indicating “unusable (use by bus)”, and the user who is a transmission source of the start-of-use notification that is received is notified that the bus stop space is currently not usable due to presence of the bus stopping schedule.

In OP504, the control unit 12 determines whether a predetermined time length passed or not. The predetermined time length is about one minute, for example. The control unit 12 is in a standby state until the predetermined time length is over (OP504: NO). In the case where the predetermined time length is over (OP504: YES), the processes illustrated in FIGS. 11 and 13 are ended.

FIG. 14 is an example of a process performed after the start time of the bus stopping schedule. In OP601, the control unit 12 determines whether the front space of the target bus stop is being used by a user or not. In the case where the front space of the target bus stop is being used by a user (OP601: YES), the process proceeds to OP603. In the case where the front space of the target bus stop is not being used by a user (OP601: NO), the process proceeds to OP602.

In OP602, the control unit 12 determines information indicating “unusable (use by bus)” as the display content on the signage 2, and transmits a display instruction to the signage 2. The signage 2 thus displays information indicating “unusable (use by bus)” to notify surroundings that the bus stop space is currently unusable due to presence of the bus stopping schedule.

In OP603, the control unit 12 determines whether approach of the bus to the target bus stop is detected or not. In the case where approach of the bus is detected (OP603: YES), the process proceeds to OP604. In OP604, the control unit 12 performs the approaching bus process. Then, the processes illustrated in FIGS. 11 and 14 are ended.

In the case where approach of the bus is not detected (OP603: NO), the process proceeds to OP605. In OP605, the control unit 12 determines whether the end time of the bus stopping schedule is reached or not. In the case where the end time of the bus stopping schedule is reached (OP605: YES), the processes illustrated in FIGS. 11 and 14 are ended. For example, in the case where the bus does not arrive at the bus stop in time for the bus stopping schedule due to delay or the like, a positive determination is made in OP605 if the bus stop space is not used by a user, and the signage 2 keeps displaying information indicating “unusable (use by bus)” during the bus stopping schedule. In the case where the end time of the bus stopping schedule is not yet reached (OP605: NO), the process proceeds to OP603.

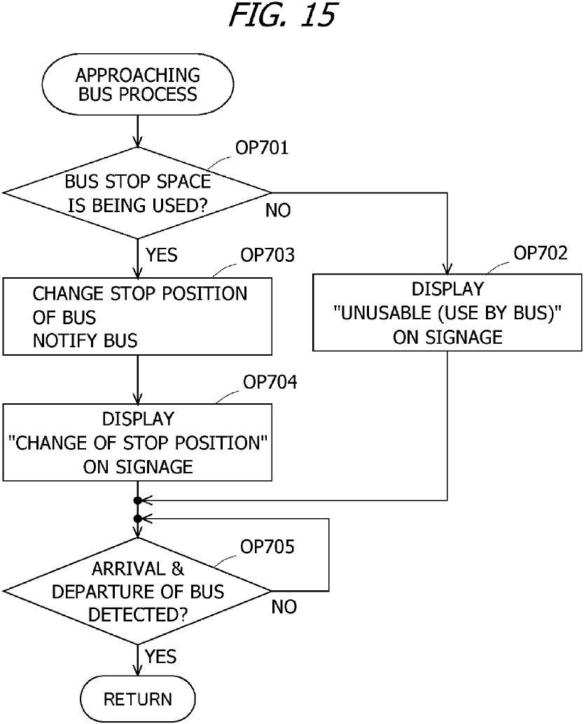

FIG. 15 is an example of a flowchart for the approaching bus process. The process illustrated in FIG. 15 is a process that is performed in OP305 in FIG. 11, OP405 in FIG. 12A, OP416 in FIG. 12B, OP424 in FIG. 12C, and OP604 in FIG. 14, for example. The process illustrated in FIG. 15 is a process performed in a case where approach of the bus to the target bus stop is detected.

In OP701, the control unit 12 determines whether the front space of the target bus stop is being used by a user or not. In the case where the front space of the target bus stop is being used by a user (OP701: YES), the process proceeds to OP703. In the case where the front space of the target bus stop is not being used by a user (OP701: NO), the process proceeds to OP702. In OP702, the control unit 12 determines information indicating “unusable (use by bus)” as the display content on the signage 2, and transmits a display instruction to the signage 2.

In OP703, the control unit 12 changes the stop position of the bus from the bus stop space to a predetermined position in the periphery of the bus stop. The stop position of the bus after change may be a position that is determined in advance, or may be determined each time. The control unit 12 notifies the bus of change of the stop position of the bus.

In OP704, the control unit 12 determines information indicating “change of stop position” as the display content on the signage 2, and transmits a display instruction to the signage 2. The control unit 12 also transmits, to the signage 2, information indicating the stop position after change, together with information indicating “change of stop position”. The signage 2 thus displays information indicating “change of stop position”, and a passenger waiting for the bus at the bus stop may grasp change of the stop position of the bus and may move to the stop position after change.

In OP705, the control unit 12 determines whether arrival and departure of the bus at and from the target bus stop are detected or not. Arrival and departure of the bus at and from the target bus stop may be detected based on the position information of the bus, or may be detected by a predetermined sensor placed at the bus stop, for example. The sensor that detects arrival and departure of the bus may be a camera, short-range wireless communication such as Bluetooth Low Energy (BLE), or the like, for example. Additionally, in OP705, in the case where the stop position of the bus is changed, arrival and departure of the bus from the stop position after change are included as “arrival and departure at and from the bus stop”.

In the case where arrival and departure of the bus at and from the target bus stop are detected (OP705: YES), the processes illustrated in FIGS. 11 and 15 are ended. In the case where arrival and departure of the bus at and from the target bus stop are not detected (OP705: NO), the process in OP705 is repeated.

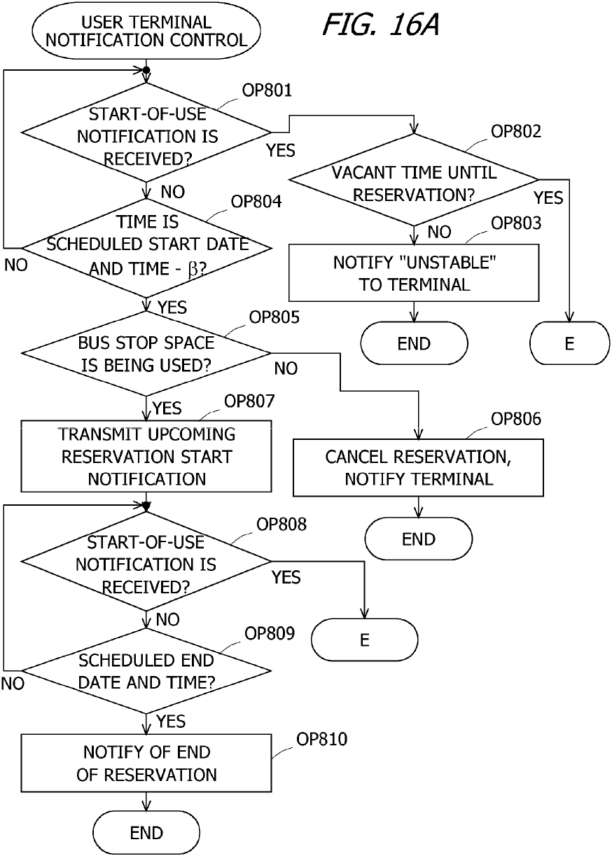

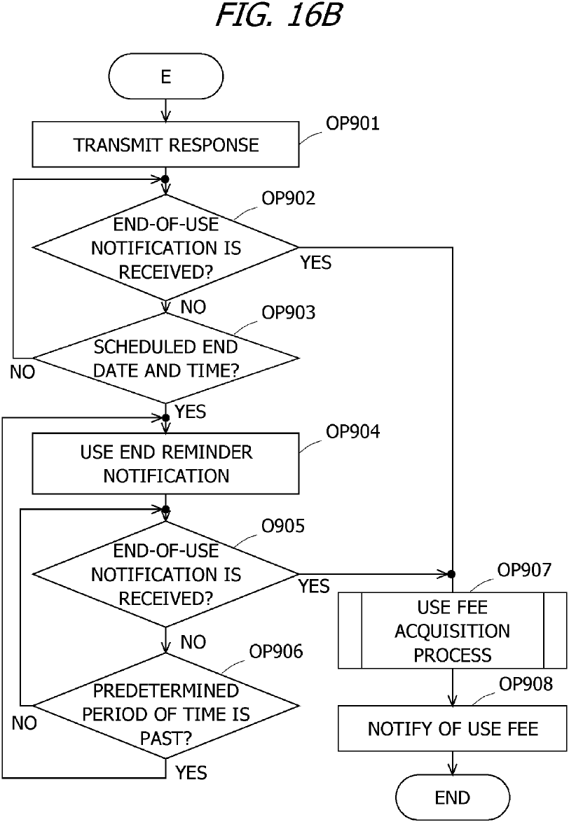

FIGS. 16A and 16B are examples of a flowchart for a user terminal notification control process by the server 1. The user terminal notification control process is a process that is performed in relation to the user terminal 3 of the reservation user. Processes illustrated in FIGS. 16A and 16B are performed for each reservation. In the following, a simple term “reservation” in FIGS. 16A and 16B is assumed to indicate the reservation that is a processing target.

In OP801, the control unit 12 determines whether the start-of-use notification is received from the user terminal 3 of the reservation user or not. In OP801, a positive determination is made in a case where the identification information of the target reservation and the identification information of the reservation that is received together with the start-of-notification match. In the case where the start-of-use notification is received from the user terminal 3 of the reservation user (OP801: YES), it is indicated that use of the bus stop space by the reservation user is started more than a predetermined time length before the scheduled start date and time of the reservation, and the process proceeds to OP802. In the case where the start-of-use notification is not received from the user terminal 3 of the reservation user (OP801: NO), the process proceeds to OP804.

OP802 and OP803 are processes that are performed in the case where the start-of-use notification is received from the user terminal 3 of the reservation user more than a predetermined time length before the scheduled start date and time of the reservation. In OP802, the control unit 12 determines whether up to the reservation is the vacant time or not, based on the schedule for the target bus stop. In the case where up to the reservation is the vacant time (OP802: YES), use of the bus stop space by the reservation user is accepted even before the scheduled start date and time of the reservation, and the process proceeds to OP901 in FIG. 16B.

In the case where up to the reservation is not the vacant time, or in other words, in the case where there is another schedule (OP802: NO), the process proceeds to OP803. In OP803, use of the bus stop space by the reservation user is not accepted, and the control unit 12 issues a notification indicating “unusable” to the user terminal 3 of the reservation user. Then, the process illustrated in FIG. 16A is ended.

In OP804, the control unit 12 determines whether a time that is a predetermined time length (“β” in the drawing) before the scheduled start date and time of the reservation is reached or not. In the case where the time that is the predetermined time length before the scheduled start date and time of the reservation is reached (OP804: YES), the process proceeds to OP805. In the case where the time that is the predetermined time length (“β” in the drawing) before the scheduled start date and time of the reservation is not reached (OP804: NO), the process proceeds OP801.

In OP805, the control unit 12 determines whether the target bus stop space is being used by another user or not. In the case where the target bus stop space is being used by another user (OP805: YES), the process proceeds to OP806. In the case where the target bus stop space is not being used by another user (OP805: NO), the process proceeds to OP807.

In OP806, the target bus stop space is being used by another user, and thus, the control unit 12 cancels the reservation of the reservation user, and notifies the user terminal 3 of the reservation user of cancellation of the reservation. Additionally, use of the target bus stop space by the other user is improper use, such as use beyond a reserved time. However, in the case where the bus stop space is being used for parking, the bus stop space is physically not available for use by the legitimate reservation user, and the reservation is cancelled in the first embodiment. However, the process that is performed in the case where the target bus stop space is used by another user is not limited thereto. The process illustrated in FIG. 16A is then ended.

In OP807, the control unit 12 transmits, to the user terminal 3 of the reservation user, the upcoming reservation start notification informing of approach of start of the reservation for use of the bus stop space.

In OP808, the control unit 12 determines whether the start-of-use notification is received from the user terminal 3 of the reservation user or not. In the case where the start-of-use notification is received from the user terminal 3 of the reservation user (OP808: YES), the process proceeds to OP901 in FIG. 16B. In the case where the start-of-use notification is not received from the user terminal 3 of the reservation user (OP808: NO), the process proceeds to OP809.

In OP809, the control unit 12 determines whether the scheduled end date and time of the reservation is reached or not. In the case where the scheduled end date and time of the reservation is reached (OP809: YES), the process proceeds to OP810. In the case where the scheduled end date and time of the reservation is not reached (OP809: NO), the process proceeds to OP808.

In OP810, because the scheduled end date and time is reached without use of the target bus stop space by the reservation user being started, the control unit 12 transmits, to the user terminal 3, a reservation end notification for notifying of end of the reserved time. Then, the process illustrated in FIG. 16A is ended.

The process illustrated in FIG. 16B is a process performed in a case where use of the target bus stop space is started by the reservation user. In OP901, the control unit 12 transmits, to the user terminal 3 of the reservation user, a response to the start-of-use notification received in OP801 or OP808.

In OP902, the control unit 12 determines whether the end-of-use notification is received from the user terminal 3 of the space user or not. A positive determination is made in OP902 in the case where the identification information of the reservation received together with the end-of-use notification matches the identification information of the target reservation. In the case where the end-of-use notification is received from the user terminal 3 of the space user (OP902: YES), the process proceeds to OP907. In the case where the end-of-use notification is not received from the user terminal 3 of the space user (OP902: NO), the process proceeds to OP903.

In OP903, the control unit 12 determines whether the scheduled end date and time of the reservation is reached or not. In the case where the scheduled end date and time of the reservation is reached (OP903: YES), the process proceeds to OP904. In the case where the scheduled end date and time of the reservation is not reached (OP903: NO), the process proceeds to OP902.

In OP904, because the end-of-use notification is not received from the user terminal 3 of the space user even though the scheduled end date and time of the reservation is expired, the control unit 12 transmits, to the user terminal 3, a use end reminder notification urging end of use of the bus stop space.

In OP905, the control unit 12 determines whether the end-of-use notification is received from the user terminal 3 of the space user or not. In the case where the end-of-use notification is received from the user terminal 3 of the space user (OP905: YES), the process proceeds to OP907. In the case where the end-of-use notification is not received from the user terminal 3 of the space user (OP905: NO), the process proceeds to OP906.

In OP906, the control unit 12 determines whether a predetermined period of time passed or not. The predetermined period of time may be freely set between 10 minutes to one hour, for example. In the case where the predetermined period of time passed (OP906: YES), the process proceeds to OP904, and the use end reminder notification is transmitted to the user terminal 3 again. In the case where the predetermined period of time is not past (OP906: NO), the process proceeds to OP905.

In OP907, the control unit 12 performs a use fee acquisition process for acquiring a use fee of the bus stop space for the space user. Details of the use fee acquisition process will be given later. The use fee of the bus stop space is acquired by the use fee acquisition process. In OP908, the control unit 12 transmits, to the user terminal 3 of the space user, a response to the end-of-use notification and a notification about the use fee. Then, the process illustrated in FIG. 16B is ended.

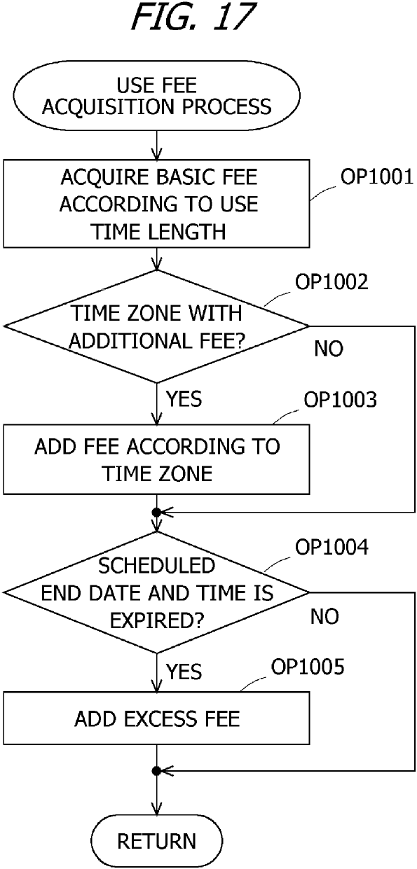

FIG. 17 is an example of a flowchart of the use fee acquisition process. The process illustrated in FIG. 17 is a process that is performed in OP907 in FIG. 16B. In OP1001, the control unit 12 acquires a basic fee according to a use time length. The use fee for the bus stop space is set for each bus stop according to geographical conditions of the bus stop or the like and on the basis of 5 to 15 minutes, for example. The use time length of the bus stop may be acquired as a time between a time indicated by the timestamp of the start-of-use notification and a time indicated by the timestamp of the end-of-use notification, for example.

In OP1002, the control unit 12 determines whether a use time zone is a time zone when an additional fee is set or not. For example, an additional fee may be set for a time zone when there is a large number of bus services. The time zone when there is a large number of bus services is a time zone of commuting hours in the morning and in the afternoon, for example. However, this is not restrictive, and the time zone when an additional fee is to be set may be freely set by the administrator of the bus stop space rental system 100.

In the case where the use time zone is a time zone when an additional fee is set (OP1002: YES), the process proceeds to OP1003. In the case where the use time zone is not a time zone when an additional fee is set (OP1002: NO), the process proceeds to OP1004. In OP1003, the control unit 12 adds a fee according to the use time zone. Additionally, in the case where the use time zone includes a time zone when an additional fee is set and a time zone when an additional fee is not set, the fee is added just for the time slot when the additional fee is set.

In OP1004, the control unit 12 determines whether use of the bus stop space exceeds the scheduled end date and time or not. In OP1004, a positive determination is made in a case where a time indicated by the timestamp of the end-of-use notification is later than the scheduled end date and time of the target reservation. In the case where use of the bus stop space exceeds the scheduled end date and time (OP1004: YES), the process proceeds to OP1005. In the case where use of the bus stop space does not exceed the scheduled end date and time (OP1004: NO), the process illustrated in FIG. 17 is ended, and the process proceeds to OP908 in FIG. 16B.

In OP1005, the control unit 12 adds a fee corresponding to a time length by which the scheduled end date and time is exceeded. An additional fee may be set on the basis of 5 to 10 minutes as the fee corresponding to a time by which the scheduled end date and time is exceeded. Then, the process illustrated in FIG. 17 is ended, and the process proceeds to OP908 in FIG. 16B.

For example, setting an additional fee for a time zone when there is a large number of bus services or setting an additional fee for use exceeding the scheduled end date and time may prevent the bus stop space from being used over a long period of time in a time zone when there is a large number of bus services.

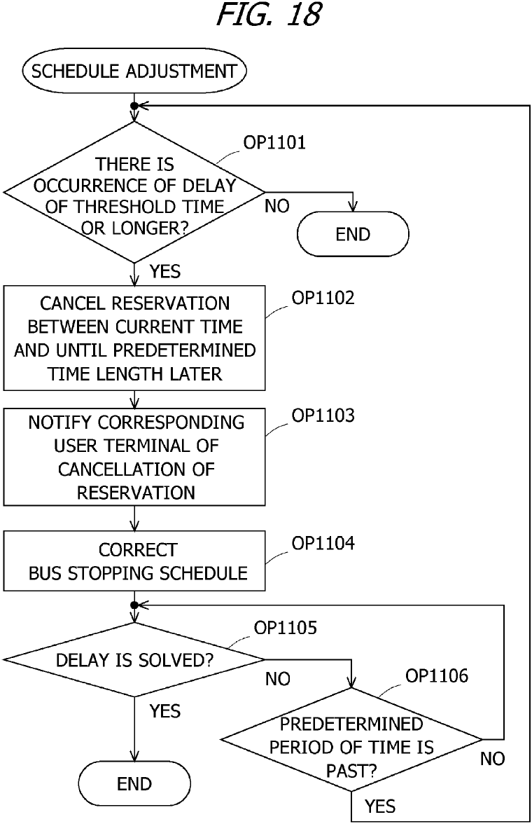

FIG. 18 is an example of a flowchart of a schedule adjustment process. Operation of a bus may be delayed depending on a state of traffic and the like, and thus, the schedule for the bus stop space is adjusted according to operation of the bus by the schedule adjustment process. The process illustrated in FIG. 18 is repeated every predetermined period. Furthermore, the process illustrated in FIG. 18 is performed for each bus stop.

In OP1101, the control unit 12 determines whether there is occurrence of a bus delay of a threshold time or longer in relation to a bus line that passes the target bus stop. An operation state of the bus may be acquired from the operation company of the bus via a network, or may be determined by acquiring congestion information, for example. A threshold time length may be freely set between 10 and 30 minutes, for example. In the case where there is occurrence of a bus delay of the threshold time or longer in relation to the bus line that passes the target bus stop (OP1101: YES), the process proceeds to OP1102. In the case where there is no occurrence of bus delay of the threshold time or longer in relation to the bus line that passes the target bus stop (OP1101: NO), the process illustrated in FIG. 18 is ended.

In OP1102, the control unit 12 cancels the reservation for the target bus stop space set between the current time and until a predetermined time length later. This is to put operation of the bus before rental of the bus stop space. In the case where there is a delay in the operation of the bus, the bus does not arrive as specified in the timetable, and an interval between arrivals becomes erratic, and thus, in the first embodiment, leaving the bus stop space open for the bus is made priority when there is a delay in the operation of the bus. However, such a case is not restrictive.

The reservation that is cancelled may be a reservation that is set within a time length that is a predetermined number of times the length of a delay time of the bus from the current time, or may be a reservation that is set in a time before delay of the bus is solved, in a case where a predicted time when delay of the bus will be solved can be acquired. However, such examples are not restrictive.

In OP1103, the control unit 12 notifies the user terminal 3 of the user whose reservation is cancelled of cancellation of the reservation. In OP1104, the control unit 12 corrects the bus stopping schedule in the schedule for the front space of the target bus stop, based on the position information of the bus running along the bus line including the target bus stop or based on information about the operation state from the bus operation company, for example. In OP1104, the bus stopping schedule may be corrected by estimating a scheduled arrival time of a bus currently running along the bus line, based on the position information of the bus, for example. Moreover, the process in OP1104 may be omitted.

In OP1105, the control unit 12 determines whether the delay of the bus is solved or not. That the delay of the bus is solved is detected based on information from the bus operation company, information about the state of traffic, or arrival of the bus as specified in the timetable, for example. In the case where the delay of the bus is solved (OP1105: YES), the process illustrated in FIG. 18 is ended. In the case where the delay of the bus is not solved (OP1105: NO) the process proceeds to OP1106.

In OP1106, the control unit 12 determines whether a predetermined period of time passed or not. The predetermined period of time may be a same time length or shorter than the period based on which the reservation is cancelled in OP1102, for example. In the case where the predetermined period of time is past (OP1106: YES), the process proceeds to OP1101, and adjustment of the schedule is further performed according to a state of the delay of the bus. In the case where the predetermined period of time is not past (OP1106: NO), the process proceeds to OP1105.

### Effects of First Embodiment

In the first embodiment, the bus stop space may be rented out to a user in the vacant time of the bus stop space by displaying information about the vacant time on the signage 2 or by publishing the same on the web, for example. Moreover, operation of the bus is put before rental of the bus stop space to the user, and operation of the bus may be prevented from being greatly affected by rental of the bus stop space to the user.

In the first embodiment, in the case where use of the bus stop space continues beyond the scheduled end date and time of the reservation, information indicating a warning is displayed on the signage 2, or the use end reminder notification is transmitted to the user terminal 3 of the space user. Furthermore, in the case where the bus stop space is used beyond the scheduled end date and time of the reservation, a predetermined fee is added to the use fee. A time of use of the bus stop space by the user may thus be prevented from being extended.

Furthermore, in the case where use of the bus stop space continues beyond the scheduled end date and time of the reservation, the stop position of the bus is changed to a predetermined position in the periphery of the bus stop, for example. Accordingly, the bus may be operated as specified in the timetable even in a state where the bus is not able to stop at the bus stop due to the bus stop space being used by a user. Furthermore, in the case where the stop position of the bus is changed, information indicating that the stop position of the bus is changed is displayed on the signage 2. A passenger waiting at the bus stop for arrival of the bus may thus be notified of the change of the stop position of the bus.

### Modification of First Embodiment

The first embodiment describes application of the bus stop space rental system 100 to a system for a so-called route bus that travels to bus stops on a fixed route at fixed times. Application of the bus stop space rental system 100 is not limited to the route bus, and application is also possible in a case where an on-demand bus uses the bus stop of the route bus, the on-demand bus being operated to arrive at a place specified by a user on a date and time specified by the user. However, there is no timetable for the bus stop for the on-demand bus as for the route bus. Accordingly, for example, reception of the reservation for use of the bus stop space may be started after reception of a reservation for boarding the on-demand bus is ended, or in other words, after a schedule of the on-demand bus to use the bus stop is established.

Furthermore, for example, a preferential vehicle may be set in relation to use of the bus stop space. For example, a preferential vehicle is a vehicle for disabled persons, a taxi, an autonomous vehicle, a delivery vehicle, or the like. The preferential vehicle may be allowed to use the bus stop space during the vacant time of the bus stop and also during the bus stopping schedule, for example. Furthermore, an additional fee does not have to be charged to the preferential vehicle even when the scheduled end date and time of the reservation is exceeded.

In the first embodiment, one user is assumed as a user who is allowed to use the bus stop space at a certain time, but this is not restrictive. For example, in the case where the bus stop space is large, a plurality of vehicles may be parked. In this case, the server 1 may control the number of vehicles that can be parked according to types of the vehicles. At the time of receiving a reservation, the server 1 also acquires information about a usage of the bus stop space from the user terminal 3. In the case where usage of the bus stop space is parking, the server 1 may further receive a reservation for parking in a same time slot from another user depending on the type of the vehicle. Furthermore, the server 1 may set a parking section according to the type of the vehicle. Information about the type of the vehicle may be acquired from the user terminal 3 at the time of user registration, or may be transmitted from the user terminal 3 together with the reservation request for use, for example. In the case where there is a plurality of spaces to be rented out at one bus stop, schedule management may be performed for each bus stop space by assigning identification information to each bus stop space.

### Second Embodiment

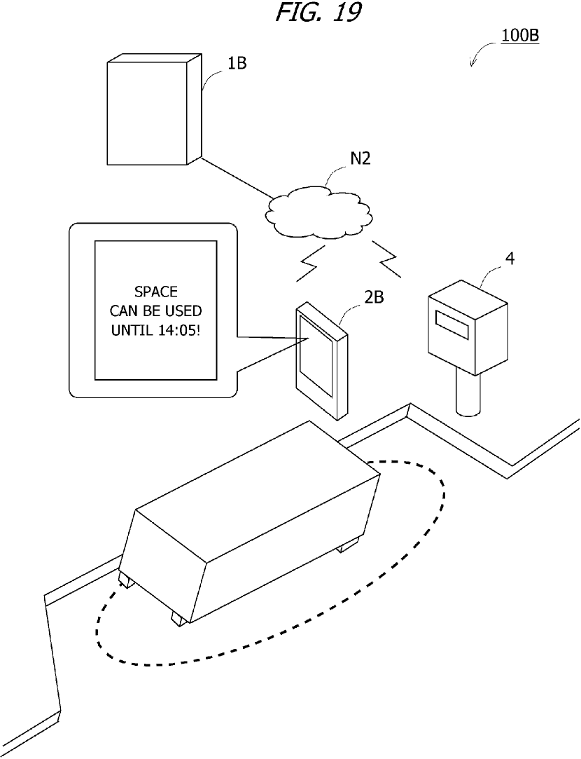

FIG. 19 is a diagram illustrating an example of a system configuration of a bus stop space rental system 100B according to a second embodiment. Unlike in the first embodiment, in the second embodiment, a reservation, via the user terminal, for use of the bus stop space is not made. In the second embodiment, in the case where the bus stop space is free, a user is allowed to park the vehicle with no advance reservation.

In the second embodiment, the bus stop space rental system 100B includes a server 1B, a signage 2B, and a parking meter 4. The server 1B and the signage 2B, and the server 1B and the parking meter 4 are connected to each other through a network N2. The network N2 is a public network such as the Internet, or a dedicated virtual or physical line, for example.

As in the first embodiment, the signage 2B displays whether the bus stop space is usable or not, for example. The parking meter 4 is a fee collection machine for a parking fee for the bus stop space. For example, a user who parks a vehicle in the bus stop space pays the parking fee in advance using the parking meter 4. The parking meter 4 includes a sensor, and detects stopping of a vehicle in the bus stop space and departure of the parked vehicle and notifies the server 1B of the same.

In the second embodiment, the server 1B acquires a state of use of the bus stop space by the user, based on a notification about a vehicle from the parking meter 4, and controls display on the parking meter 4 and the signage 2B. Additionally, in the second embodiment, because there is no advance reservation for use of the bus stop space, and because the parking meter 4 detects stopping and parking of a vehicle in the bus stop space, use of the bus stop space is limited to parking and stopping of vehicles. Moreover, description overlapping that in the first embodiment will be omitted.

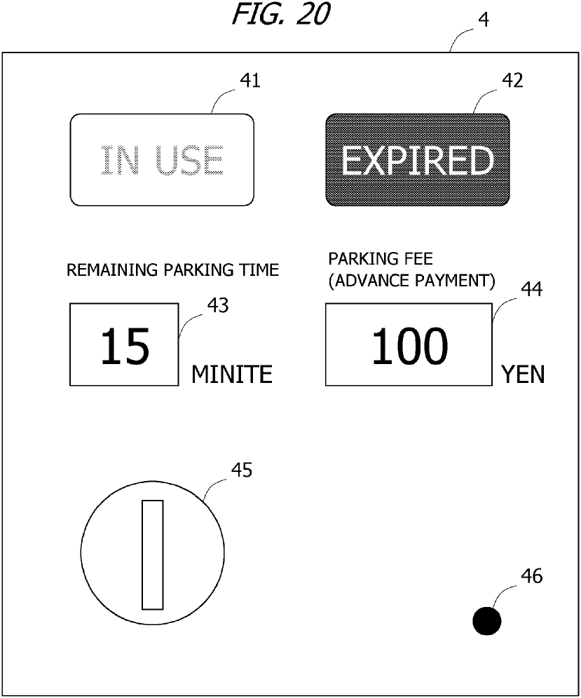

FIG. 20 is an example of an external appearance of the parking meter 4. The parking meter 4 includes an “in use” lamp 41, an “expired” lamp 42, a display 43 for displaying remaining parking time, a display 44 for displaying parking fee, a coin slot 45, and a sensor 46. The “in use” lamp 41 is a lamp that indicates that the bus stop space is being used, by being turned on. The “expired” lamp 42 is turned on when a remaining time displayed on the display 43 for displaying remaining parking time reaches zero minutes, to indicate that use is expired.

The display 43 for displaying remaining parking time is a display that displays a remaining time when the bus stop space can be used. Before the bus stop space is used, the display 43 for displaying remaining parking time displays a remaining time when parking is possible. For example, when use of the bus stop space is started, countdown is started for the remaining time displayed, at a time of start, on the display 43 for displaying remaining parking time.

The display 44 for displaying parking fee displays a parking fee corresponding to the remaining time that is displayed on the display 43 for displaying remaining parking time at the time of start of use of the bus stop space. The sensor 46 is a sensor that detects parking and departure of a vehicle from the bus stop space. For example, the sensor 46 is a sensor that detects presence of an object by emitting ultrasonic waves, radio waves, infrared rays or the like and by using reflected waves. Additionally, the configuration of the parking meter 4 is an example, and is not limited to the example illustrated in FIG. 20.

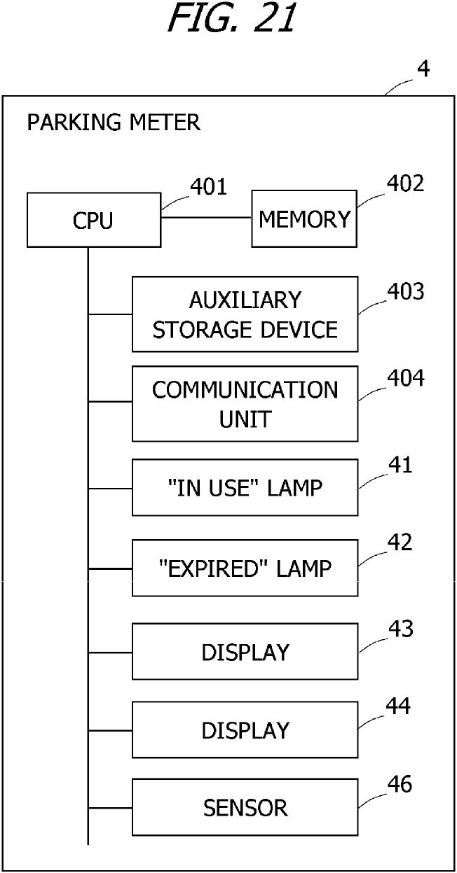

FIG. 21 is a diagram illustrating an example of a hardware configuration of the parking meter 4. As hardware components, the parking meter 4 includes a CPU 401, a memory 402, an auxiliary storage device 403, a communication unit 404, the “in use” lamp 41, the “expired” lamp 42, the display 43 for displaying remaining parking time, the display 44 for displaying parking fee, and the sensor 46. The CPU 401, the memory 402, the auxiliary storage device 403, and the communication unit 404 are the same as the CPU 101, the memory 102, the auxiliary storage device 103, and the communication unit 104, respectively. The “in use” lamp 41, the “expired” lamp 42, the display 43 for displaying remaining parking time, the display 44 for displaying parking fee, and the sensor 46 are as described with reference to FIG. 20.

The server 1B and the signage 2B in the second embodiment have same hardware configurations as those in the first embodiment. Furthermore, a functional configuration of the server 1B is also the same as that in the first embodiment. However, the second embodiment is different in that the reservation for the bus stop space is not made and that the user terminal 3 is not included, and processes related thereto are not performed. More specifically, in the second embodiment, the server 1B performs the schedule creation process in FIG. 9, and the signage display control process in FIGS. 11 to 15. However, of these processes, the process related to reservation of the bus stop space is not performed. Furthermore, the start-of-use notification and the end-of-use notification from the user terminal 3 are replaced by notifications of detection of start and end of parking from the parking meter 4.

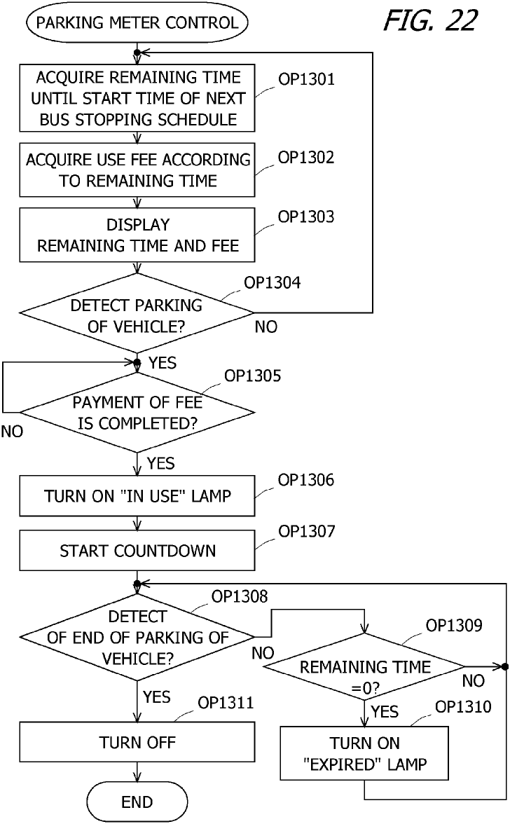

FIG. 22 is an example of a flowchart of a control process for the parking meter 4 by the server 1 according to the second embodiment. The process illustrated in FIG. 22 is repeated every predetermined period. The process illustrated in FIG. 22 is performed for each parking meter 4, or in other words, each bus stop space.

In OP1301, the control unit 12 acquires a remaining time until the start time of the next bus stopping schedule. In OP1302, the control unit 12 acquires the use fee according to the remaining time. In OP1303, the control unit 12 causes the remaining time and the fee to be displayed on the display 43 for displaying remaining parking time and the display 44 for displaying parking fee, respectively.

In OP1304, the control unit 12 determines whether detection of parking of a vehicle in the bus stop space is received from the parking meter 4 or not. In the case where detection of parking of a vehicle is received from the parking meter 4 (OP1304: YES), the process proceeds to OP1305. In the case where detection of parking of a vehicle is not received from the parking meter 4 (OP1304: NO), the process proceeds to OP1301.

In OP1305, the control unit 12 determines whether payment of the fee is completed or not. Whether or not payment of the fee is completed is determined based on a notification from the parking meter 4, for example. In the case where payment of the fee is completed (OP1305: YES), the process proceeds to OP1306. In the case where payment of the fee is not completed (OP1305: NO), the control unit 12 stays in a standby state until the fee is paid.

In OP1306, the control unit 12 instructs the parking meter 4 to turn on the “in use” lamp 41. In OP1307, the control unit 12 starts countdown of the remaining parking time. In OP1308, the control unit 12 determines whether detection of end of parking of the vehicle in the bus stop space is received or not. In the case where detection of end of parking of the vehicle is received from the parking meter 4 (OP1308: YES), the process proceeds to OP1311. In the case where detection of end of parking of the vehicle is not received from the parking meter 4 (OP1308: NO), the process proceeds to OP1309.

In OP1309, the control unit 12 determines whether the remaining parking time is zero or not. In the case where the remaining parking time is zero (OP1309: YES), the process proceeds to OP1310. In the case where the remaining parking time is not zero (OP1309: NO), the process proceeds to OP1308. In OP1310, the control unit 12 instructs the parking meter 4 to turn on the “expired” lamp 42. Then, the process proceeds to OP1308.

In OP1311, the control unit 12 instructs the parking meter 4 to turn off the “in use” lamp 41 and the “expired” lamp 42 (if turned on). Then, the process illustrated in FIG. 22 is ended.

According to the second embodiment, the bus stop space may be rented out even in the case where there is no advance reservation. Additionally, as a modification of the second embodiment, the system may be constructed without including the signage 2B. In the case where the system is constructed with the server 1B and the parking meter 4 without including the signage, the parking meter 4 is an example of “display apparatus for displaying information about use of the front space of the bus stop”.

### Other Embodiments

The embodiments described above are examples, and the present disclosure may be changed and carried out as appropriate without departing from the gist of the present disclosure.

The processes and means described in the present disclosure may be freely combined to the extent that no technical conflict exists.

A process which is described to be performed by one device may be performed among a plurality of devices. Processes described to be performed by different devices may be performed by one device. Each function to be implemented by a hardware component (server component) in a computer system may be flexibly changed.

The present disclosure may also be implemented by supplying a computer program for implementing a function described in the embodiment above to a computer, and by reading and executing the program by at least one processor of the computer. Such a computer program may be provided to a computer by a non-transitory computer-readable storage medium which is connectable to a system bus of a computer, or may be provided to a computer through a network. The non-transitory computer-readable storage medium may be any type of disk such as a magnetic disk (floppy (registered trademark) disk, a hard disk drive (HDD), etc.), an optical disk (CD-ROM, DVD disk, Blu-ray disk, etc.), a read only memory (ROM), a random access memory (RAM), an EPROM, an EEPROM, a magnetic card, a flash memory, an optical card, and any type of medium which is suitable for storing electronic instructions.

What is claimed is:

1. An information processing apparatus comprising a processor configured to:
acquire a vacant time of a front space of a bus stop based on information about operation of a bus associated with the bus stop, and
output information about the vacant time of the front space of the bus stop that is acquired, as a time when rental of the front space of the bus stop is allowed.

2. The information processing apparatus according to claim 1, wherein the processor is configured to control display content on a display apparatus for displaying information about use of the front space of the bus stop, based on at least the information about the operation of the bus associated with the bus stop, the display apparatus being placed at the bus stop.

3. The information processing apparatus according to claim 2, wherein the processor is configured to cause the display apparatus to display information indicating that the front space of the bus stop is usable in the vacant time of the front space of the bus stop.

4. The information processing apparatus according to claim 3, wherein the processor is configured to cause the display apparatus to display the information indicating that the front space of the bus stop is usable, and information indicating until when the front space of the bus stop is usable.

5. The information processing apparatus according to claim 2, wherein, in a case where a first bus scheduled to stop at the bus stop is approaching the bus stop, the processor is configured to change the display content on the display apparatus to information indicating that the front space of the bus stop is not usable.

6. The information processing apparatus according to claim 2, wherein, in a case where a use time of the front space of the bus stop is longer than scheduled, the processor is configured to cause the display apparatus to display information urging end of use of the front space of the bus stop.

7. The information processing apparatus according to claim 2, wherein the processor is further configured to:
change a stop position of a first bus scheduled to stop at the bus stop to a periphery of the bus stop, in a case where the first bus is detected to be approaching the bus stop and the front space of the bus stop is being used, and
cause the display apparatus to display information indicating the stop position of the first bus after change.

8. The information processing apparatus according to claim 2, wherein the processor is further configured to:
change a stop position of a first bus scheduled to stop at the bus stop to a periphery of the bus stop, in a case where the first bus is detected to be approaching the bus stop and the front space of the bus stop is being used, and
notify the first bus of the stop position after change.

9. The information processing apparatus according to claim 1, wherein the processor is further configured to:
receive a reservation for use of the front space in relation to a first period of time in the vacant time of the front space of the bus stop, and
manage a schedule for the front space of the bus stop based on the information about the operation of the bus associated with the bus stop and information about the reservation for use of the front space.

10. The information processing apparatus according to claim 9, wherein the processor is further configured to acquire a fee for use of the front space of the bus stop, according to at least one of a time zone of use or exceedance or non-exceedance of a use time.

11. The information processing apparatus according to claim 1, wherein the information about the operation of the bus associated with the bus stop is a timetable for the bus stop.

12. The information processing apparatus according to claim 1, wherein the information about the operation of the bus associated with the bus stop is position information of at least one bus that is scheduled to stop at the bus stop.

13. A method executed by a computer, the method comprising:
acquiring a vacant time of a front space of a bus stop based on information about operation of a bus associated with the bus stop; and
outputting information about the vacant time of the front space of the bus stop that is acquired, as a time when rental of the front space of the bus stop is allowed.

14. The method according to claim 13, wherein the computer controls display content on a display apparatus for displaying information about use of the front space of the bus stop, based on at least the information about the operation of the bus associated with the bus stop, the display apparatus being placed at the bus stop.

15. The method according to claim 14, wherein, the computer causes the display apparatus to display information indicating that the front space of the bus stop is usable in the vacant time of the front space of the bus stop.

16. The method according to claim 14, wherein, in a case where a use time of the front space of the bus stop is longer than scheduled, the computer causes the display apparatus to display information urging end of use of the front space of the bus stop.

17. The method according to claim 14, wherein the computer further
changes a stop position of a first bus scheduled to stop at the bus stop to a periphery of the bus stop, in a case where the first bus is detected to be approaching the bus stop and the front space of the bus stop is being used, and
causes the display apparatus to display information indicating the stop position of the first bus after change.

18. The method according to claim 14, wherein the computer further
changes a stop position of a first bus scheduled to stop at the bus stop to a periphery of the bus stop, in a case where the first bus is detected to be approaching the bus stop and the front space of the bus stop is being used, and
notifies the first bus of the stop position after change.

19. The method according to claim 13, wherein the computer further
receives a reservation for use of the front space in relation to a first period of time in the vacant time of the front space of the bus stop, and
manages a schedule for the front space of the bus stop based on the information about the operation of the bus associated with the bus stop and information about the reservation for use of the front space.

20. A non-transitory computer-readable recording medium on which a program is recorded, the program for causing a computer to:
receive specification of a first period of time in a vacant time of a front space of a bus stop, and
transmit a request for use of the front space in relation to the first period of time.
